(19) United States
(12) Patent Application Publication
(10) Pub. No.: US 2024/0260635 A1
(43) Pub. Date: Aug. 8, 2024

(54) STABLE THICKENERS AND NUTRITIONAL PRODUCTS TO PROMOTE SAFE SWALLOWING FOR INDIVIDUALS WITH DYSPHAGIA AND METHODS OF MAKING AND USING SAME

(71) Applicant: SOCIETE DES PRODUITS NESTLE S.A., Vevey (CH)

(72) Inventors: MICHAEL REUBEN JEDWAB, Lausanne (CH); NANCY STEVENSON, Linwood, NJ (US); ALIREZA ABBASPOURRAD, Ithaca, NY (US)

(21) Appl. No.: 18/561,411

(22) PCT Filed: May 20, 2022
(86) PCT No.: PCT/EP2022/063701

§ 371 Date: Nov. 16, 2023

Related U.S. Application Data
(60) Provisional application No. 63/194,618, filed on May 28, 2021.

(51) Int. Cl. A23L 29/269; A23L 3/01; A23L 3/358

(52) U.S. Cl. CPC A23L 29/271; A23L 3/01; A23L 3/358

(57) ABSTRACT

The present disclosure is related to a stable nutritional product, a thickener formulated for dilution into the nutritional composition, a use of the nutritional product, a method for making the nutritional product, a method for enhancing physical stability, especially with regards to rheological and in particular “cohesive” properties of the nutritional product, and a related system. The physical stability, especially with regards to rheological and in particular cohesive properties of a nutritional product consumed in liquid form and containing a beta-glucan can be enhanced by reducing and/or preventing growth of microorganisms in the nutritional product, and/or deactivating enzymes in the nutritional product, and/or preventing hydrolysis of the beta-glucan in the nutritional product.

### BACKGROUND

The present disclosure is related to a stable thickener formulated for dilution into a nutritional composition, a nutritional product including the thickener, a use of the nutritional product, a method for making the nutritional product, a method for enhancing physical stability, especially with regards to rheological and in particular “cohesive” properties of the nutritional product, and a related system.

Dysphagia is a medical term for the symptom of difficulty in swallowing. Dysphagia may be a sensation that suggests a difficulty in a passage of a solid or a liquid (i.e., a nutritional product) from the mouth to the stomach.

During processing of a nutritional product in the mouth and during swallowing, a viscosity of the nutritional product changes due to shear forces. In most cases, the viscosity of the nutritional product decreases when the shear forces and the shear rate acting on the nutritional product (e.g., chewing forces) increase. Individuals who suffer from dysphagia often require a thickened nutritional product. Thickening of the nutritional product is achieved to increase, in particular, the shear viscosity of the product by adding a thickener such as a starch or gum thickener. The thickened nutritional product makes an individual with dysphagia less likely to aspirate during passage of the nutritional products from the mouth to the stomach.

Individuals with dysphagia may find that nutritional products cause coughing, spluttering or even choking, and therefore thickened nutritional products enable the individuals who suffer from dysphagia to swallow safely. The addition of a thickener is thought to improve a bolus control and timing of swallowing, but the resultant thickness is disliked by individuals who suffer from dysphagia due to the extra swallowing effort required. Moreover, the thickener leaves residues with high levels of viscosity, resulting in undesirable organoleptic properties. This is particularly relevant for liquids and beverages, as a dysphagia patient would expect a liquid that still has the organoleptic properties of a real thin liquid instead of a liquid product showing high viscosity. Furthermore, thickened nutritional products wherein merely shear viscosity is increased usually lack the cohesiveness that saliva typically provides to food boluses. Oral saliva has elasticity, high extensional viscosity and plays an important role in bolus formation, promoting the bolus cohesiveness of masticated particles.

Dysphagia is classified into three major types: oropharyngeal dysphagia, esophageal dysphagia and functional dysphagia.

Oropharyngeal dysphagia is generally not treatable with medication. Oropharyngeal dysphagia affects individuals of all ages but is more prevalent in older individuals. Worldwide, oropharyngeal dysphagia affects approximately 22 million people over the age of 50 years. Oropharyngeal dysphagia is often a consequence of an acute event such as a stroke, brain injury, or surgery for oral or throat cancer. In addition, radiotherapy and chemotherapy may weaken the muscles and degrade the nerves associated with the physiology and nervous innervation of the swallow reflex. Oropharyngeal dysphagia is also common for individuals with progressive neuromuscular diseases, such as Parkinson's disease, to experience increasing difficulty in swallowing initiation. Representative causes of oropharyngeal dysphagia include those associated neurological illnesses (brainstem tumors, head trauma, stroke, cerebral palsy, Guillain-Barre syndrome, Huntington's disease, multiple sclerosis, polio, post-polio syndrome, Tardive dyskinesia, metabolic encephalopathies, amyotrophic lateral sclerosis, Parkinson's disease, dementia), infectious illnesses (diphtheria, botulism, Lyme disease, syphilis, mucositis [herpetic, cytomegalovirus, candida, etc.]), autoimmune illnesses (lupus, scleroderma, Sjogren's syndrome), metabolic illnesses (amyloidosis, Cushing's syndrome, thyrotoxicosis, Wilson's disease), myopathic illnesses (connective tissue disease, dermatomyositis, myasthenia gravis, myotonic dystrophy, oculopharyngeal dystrophy, polymyositis, sarcoidosis, paraneoplastic syndromes, inflammatory myopathy), iatrogenic illnesses (medication side effects [e.g., chemotherapy, neuroleptics, etc.], post surgical muscular or neurogenic, radiation therapy, corrosive [pill injury, intentional]), and structural illnesses (cricopharyngeal bar, Zenker's diverticulum, cervical webs, oropharyngeal tumors, osteophytes and skeletal abnormalities, congenital [cleft palate, diverticulae, pouches, etc.]).

Esophageal dysphagia can affect individuals of all ages. Esophageal dysphagia is generally treatable with medications and is considered a less serious form of dysphagia. Esophageal dysphagia is often a consequence of mucosal, mediastinal, or neuromuscular diseases. Mucosal (intrinsic) diseases narrow the lumen through inflammation, fibrosis, or neoplasia associated with various conditions (e.g., peptic stricture secondary to gastroesophageal reflux disease, esophageal rings and webs [e.g., sideropenic dysphagia or Plummer-Vinson syndrome], esophageal tumors, chemical injury [e.g., caustic ingestion, pill esophagitis, sclerotherapy for varices], radiation injury, infectious esophagitis, and eosinophilic esophagitis). Mediastinal (extrinsic) diseases obstruct the esophagus by direct invasion or through lymph node enlargement associated with various conditions (tumors [e.g., lung cancer, lymphoma], infections [e.g., tuberculosis, histoplasmosis], and cardiovascular [dilated auricula and vascular compression]). Neuromuscular diseases may affect the esophageal smooth muscle and its innervation, disrupting peristalsis or lower esophageal sphincter relaxation, or both, commonly associated with various conditions (achalasia [both idiopathic and associated with Chagas disease], scleroderma, other motility disorders, and a consequence of surgery [i.e., after fundoplication and anti-reflux interventions]). Individuals with intraluminal foreign bodies commonly experience acute esophageal dysphagia.

Functional dysphagia is defined in some patients wherein no organic cause for dysphagia can be found.

Dysphagia is not generally diagnosed. Dysphagia has major consequences on health and healthcare costs on individuals who suffer from dysphagia. Individuals who suffer from severe dysphagia experience a sensation of impaired passage of nutritional products from the mouth to the stomach, occurring immediately after swallowing. Among community dwelling individuals, perceived symptoms may bring the individuals who suffer from dysphagia to see a doctor. Among institutionalized individuals, health care practitioners may observe symptoms or hear comments from the individual who suffers from dysphagia or a family member suggestive of swallowing impairment and then recommend evaluation of the individual who suffers from dysphagia by a specialist. The general awareness of swallowing impairments is low among front-line practitioners, so dysphagia often is undiagnosed and untreated. Yet, a patient can be clinically evaluated and dysphagia diagnosis can be determined through referral to a swallowing specialist (e.g. speech language pathologist).

The general awareness of swallowing impairments is low among front-line practitioners. Many people (especially those who are elderly) suffer with undiagnosed and untreated swallowing impairments. One reason is that front-line community care practitioners (e.g., general practitioners/geriatricians, home care nurses, physical therapists, etc.) do not typically screen for the condition. If they are aware of the severity of swallowing impairments, they commonly do not use an evidence-based method of screening.

A severity of dysphagia may vary from: (i) minimal (perceived) difficulty in safely swallowing nutritional products, (ii) an inability to swallow nutritional products without significant risk for aspiration or choking, and (iii) a complete inability to swallow nutritional products. An inability to properly swallow nutritional products may be due to food boluses of the nutritional products being broken into smaller fragments, which may enter the airway or leave unwanted residues in the oropharyngeal and/or esophageal tract during the swallowing process (e.g., aspiration). If enough material enters the lungs, the patient may drown on the nutritional products that have accumulated in the lungs. Even small volumes of aspirated nutritional products may lead to bronchopneumonia infection, and chronic aspiration may lead to bronchiectasis and may cause some cases of asthma. Swallowing efficiency is linked to the amount of residues in the throat.

Silent aspiration is a common condition among the elderly and refers to the passage of swallowed material below the vocal cords without coughing. People may compensate for less-severe swallowing impairments by self-limiting the diet. The aging process itself, coupled with chronic diseases such as hypertension or osteoarthritis, predisposes the elderly to subclinical dysphagia that may go undiagnosed and untreated until a clinical complication such as pneumonia, dehydration, malnutrition and related complications occurs.

Dysphagia and aspiration impacts upon quality of life, morbidity and mortality. Twelve-month mortality is high (45%) among individuals in institutional care who have dysphagia and aspiration. The economic burden of the clinical consequences arising from lack of diagnosis and early management of dysphagia are therefore significant.

As noted, pneumonia is a common clinical consequence of dysphagia. Pneumonia may require acute hospitalisation and emergency room visits. Among those that develop pneumonia due to aspiration, the differential diagnosis of ‘aspiration pneumonia’ is not necessarily indicated as a result of current care practices. Based on U.S. healthcare utilisation surveys from recent years, pneumonia accounted for over one million hospital discharges and an additional 392,000 were attributable to aspiration pneumonia. Individuals who have general pneumonia as the principal diagnosis have a mean 6 day hospital length of stay and incur over $18,000 in costs for hospital care. It is expected that aspiration pneumonia would carry higher costs for hospital care, based on a mean 8 day length of hospital stay. Pneumonia is life-threatening among persons with dysphagia, the odds of death within 3 months is about 50% (van der Steen et al. 2002). In addition, an acute insult such as pneumonia often initiates the downward spiral in health among elderly. An insult is associated with poor intakes and inactivity, resulting in malnutrition, possible reduction in immune system function, functional decline, and frailty. Specific interventions (e.g., to promote oral health, help restore normal swallow, or reinforce a swallow-safe bolus) would benefit persons at risk for (due to aspiration of oropharyngeal contents, including silent aspiration) or experiencing recurrent pneumonia. Swallowing safety is linked to aspiration pneumonia, quantified on the Penetration-Aspiration Scale (PAS) or Rosenbek scale.

Similar to pneumonia, dehydration is a life-threatening clinical complication of dysphagia. Dehydration is a common co-morbidity among hospitalised individuals with neurodegenerative diseases (thus, likely to have a swallowing impairment). The conditions of Alzheimer's disease, Parkinson's disease, and multiple sclerosis account for nearly 400,000 U.S. hospital discharges annually, and up to 15% of these patients suffer dehydration. Having dehydration as the principal diagnosis is associated with a mean 4 day length of hospital stay and over $11,000 in costs for hospital care. Nevertheless, dehydration is an avoidable clinical complication of dysphagia.

Malnutrition and related complications (e.g., [urinary tract] infections, pressure ulcers, increased severity of dysphagia [need for more-restricted food options, tube feeding, and/or Percutaneous Endoscopic Gastrostomy (PEG) tube placement and reduced quality of life], dehydration, functional decline and related consequences [falls, dementia, frailty, loss of mobility, and loss of autonomy]) can arise when swallowing impairment leads to fear of choking on food and liquids, slowed rate of consumption, and self-limited food choices. If uncorrected, inadequate nutritional intake exacerbates dysphagia as the muscles that help facilitate normal swallow weaken as physiological reserves are depleted. Malnutrition is associated with having more than 3-times greater risk of infection. Infections are common in individuals with neurodegenerative diseases (thus, likely to have a chronic swallowing impairment that jeopardizes dietary adequacy). The conditions of Alzheimer's disease, Parkinson's disease, and multiple sclerosis account for nearly 400,000 U.S. hospital discharges annually, and up to 32% of these patients suffer urinary tract infection.

Malnutrition has serious implications for patient recovery. Malnourished patients have longer length of hospital stay, are more likely to be re-hospitalized, and have higher costs for hospital care. Having malnutrition as the principal diagnosis is associated with a mean 8 day length of hospital stay and nearly $22,000 in costs for hospital care. Furthermore, malnutrition leads to unintentional weight loss and predominant loss of muscle and strength, ultimately impairing mobility and the ability to care for oneself. With the loss of functionality, caregiver burden becomes generally more severe, necessitating informal caregivers, then formal caregivers, and then institutionalization. However, malnutrition is an avoidable clinical complication of dysphagia.

Among persons with neurodegenerative conditions (e.g., Alzheimer's disease), unintentional weight loss (a marker of malnutrition) precedes cognitive decline. In addition, physical activity can help stabilize cognitive health. Thus, nutritional adequacy is important among persons with neurodegenerative conditions to help them have the strength and endurance to participate in regular therapeutic exercise and guard against unintentional weight loss, muscle wasting, loss of physical and cognitive functionality, frailty, dementia, and progressive increase in caregiver burden.

Falls and related injuries are a special concern among elderly with neurodegenerative conditions, associated with loss of functionality. Falls are the leading cause of injury deaths among older adults. Furthermore, fall-related injuries among elderly accounted for more than 1.8M U.S. emergency room visits in a recent year. Direct medical costs totaled $179M for fatal and $19.3B for nonfatal fall-related injuries in the period of a year. As an effect of an ambitious non-payment for performance initiative introduced in U.S. hospitals in October 2008, Medicare will no longer pay hospitals for treatment cost of falls and related injuries that occur during the hospital stay. Hospitals will face a loss of about $50,000 for each elderly patient who falls and suffers hip fracture while in hospital care. This new quality initiative is based on the premise that falls are an avoidable medical error. In other words, falls are preventable within reason by applying evidence-based practices including medical nutrition therapy as nutritional interventions are efficacious in the prevention of falls and related injuries (e.g., fractures) among the elderly.

Chewing and swallowing difficulties are recognised risk factors for pressure ulcer development. Pressure ulcers are considered an avoidable medical error, preventable within reason by applying evidence-based practices (including nutritional care, as pressure ulcers are more likely when nutrition is inadequate). Pressure ulcers are a significant burden to the health care system. In U.S. hospitals in 2006, there were 322,946 cases of medical error connected with pressure ulcer development. The average cost of healing pressure ulcers depends on the stage, ranging from about $1,100 (for stage II) to about $10,000 (for stage III & IV pressure ulcers). Thus, the estimated cost of healing the cases of medical error connected with pressure ulcer development in one year, is in the range of $323M to $3.2B. As an effect of an ambitious non-payment for performance initiative introduced in U.S. hospitals in October 2008, Medicare will no longer pay hospitals for treatment cost of pressure ulcers that develop during the hospital stay (up to $3.2B annually). Pressure ulcers are preventable within reason, in part, by assuring nutritional intakes are adequate. Furthermore, specific interventions including the use of specialised nutritional supplements help reduce the expected time to heal pressure ulcers once they've developed.

These conditions as discussed above may result in social isolation of individuals who suffer from these conditions. Social isolation is a state of complete or near-complete lack of contact between an individual and society. It can be an issue for individuals of any age, though symptoms may differ by age group. Individuals with dysphagia often need being tube fed and/or require PEG placement and thus may need to stay home or in care facilities and/or hospitals for lengthy periods of time. They cannot experience the psycho-social aspects of nutritional products associated with general well-being due to lack of adequate swallowing ability, which can result in very negative psychological and/or emotional effects. These individuals may tend to have limited to no communication with family, acquaintances or friends, and/or willfully avoid any contact with other humans when those opportunities do arise because of their physical isolation and/or negative psychological and/or emotional state. Social isolation in turn can further lead to feelings of loneliness, fear of others, or negative self-esteem, which further aggravates the individuals' negative psychological and/or emotional state.

In U.S. long-term care facilities, quality of care standards are enforced via the frequent regulatory survey. Surveyors will consider facilities out of compliance when they uncover evidence of actual or potential harm/negative outcomes. The range of penalties includes fines, forced closure, as well as lawsuits and settlement fees. The Tag F325 (nutrition) survey considers significant unplanned weight change, inadequate food/fluid intake, impairment of anticipated wound healing, failure to provide a therapeutic diet as ordered, functional decline, and fluid/electrolyte imbalance as evidence for providing sub-standard nutritional care. The Tag F314 (pressure ulcers) survey mandates that the facility must ensure that a resident who is admitted without pressure ulcers does not develop pressure ulcers unless deemed unavoidable. In addition, that a resident having pressure ulcers receives necessary treatment and services to promote healing, prevent infection and prevent new pressure ulcers from developing.

Therefore considering the prevalence of dysphagia and the possible complications related thereto, and the costs associated with same, it would be beneficial to provide nutritional products that promote safer swallowing of boluses of the nutritional products in individuals who suffer from dysphagia. Such nutritional products would improve the lives of a large and growing number of individuals who suffer from dysphagia. Specific interventions (e.g., to promote oral health, help restore normal swallowing, or reinforce a swallow-safe bolus) can enable individuals to eat orally as opposed to being tube fed and/or requiring PEG placement) and experience the psycho-social aspects of nutritional products associated with general well-being while guarding against the potentially negative consequences that result from lack of adequate swallowing ability. Improvements in the intake of nutritional products by individuals who suffer from dysphagia may also enable such individuals to swallow a wider variety of nutritional products safely and comfortably, which may lead to an overall healthier condition of the individual and prevent further health-related decline. There is therefore a need to overcome the aforementioned drawbacks and to provide natural cohesiveness that saliva provides to food boluses of nutritional products when being consumed by an individual.

Further, commercial products, such as high molecular weight beta-glucan, may degrade over time. The degradation of the beta-gluten impacts the cohesiveness of the product and/or shortens the shelf life of the commercial products. Loss of cohesiveness makes the products no longer suitable for individuals with dysphagia.

### SUMMARY

The present disclosure is related to a stable nutritional product, a thickener formulated for dilution into the nutritional composition, a use of the nutritional product, a method for making the nutritional product, a method for enhancing physical stability, especially with regards to rheological and in particular “cohesive” properties of the nutritional product, and a related system.

In a first aspect, the present disclosure provides a method of enhancing physical stability, especially with regards to rheological and in particular cohesive properties of a nutritional product consumed in liquid form, the nutritional product containing a beta-glucan, the method comprising at least one of preventing degradation of the beta-glucan in the nutritional product; reducing degradation of the beta-glucan in the nutritional product; maintaining viscosity and/or relaxation time of the nutritional product; or reducing a rate of decreasing of the viscosity and/or the relaxation time of the nutritional product. The method can include at least one of reducing and/or preventing growth of microorganisms in the nutritional product; deactivating enzymes in the nutritional product; or preventing hydrolysis of the beta-glucan in the nutritional product.

The method may comprise a treatment selected from the group consisting of: adding to the nutritional product a stabilizer selected from the group consisting of Na₂HPO₄, sodium azide, potassium sorbate, sodium benzoate, sodium citrate, citric acid, hydrochloric acid, tartaric acid, protease, and combinations thereof; heating the nutritional product to a temperature between about 30° C. and about 100° C.; adjusting a pH of the nutritional product to from about 3 to about 7; and combinations thereof.

In one embodiment, the stabilizer may comprise at least one of Na₂HPO₄ or sodium azide. In another embodiment, the stabilizer may comprise at least one of sodium azide or protease. In another embodiment, the stabilizer may comprise potassium sorbate and tartaric acid.

In another aspect, the present disclosure provides a method of preventing degradation of a beta-glucan in a nutritional product comprising the beta-glucan, the method comprising a treatment selected from the group consisting of: adding to the nutritional product a stabilizer selected from the group consisting of Na₂HPO₄, sodium azide, potassium sorbate, sodium benzoate, sodium citrate, citric acid, hydrochloric acid, tartaric acid, protease, and combinations thereof; heating the nutritional product to a temperature between about 30° C. and about 100° C.; adjusting a pH of the nutritional product to from about 3 to about 7; and combinations thereof.

In another aspect, the present disclosure provides a method of making a nutritional product, the method comprising: preparing the nutritional product by diluting a thickener comprising a beta-glucan in a diluent; and subjecting the nutritional product to a treatment selected from the group consisting of: adding to the nutritional product a stabilizer selected from the group consisting of Na₂HPO₄, sodium azide, potassium sorbate, sodium benzoate, sodium citrate, citric acid, hydrochloric acid, tartaric acid, protease, and combinations thereof; heating the nutritional product to a temperature between about 30° C. and about 100° C.; adjusting a pH of the nutritional product to from about 3 to about 7; and combinations thereof.

In another aspect, the present disclosure provides a nutritional product comprising a beta-glucan and a stabilizer selected from the group consisting of Na₂HPO₄, sodium azide, potassium sorbate, sodium benzoate, sodium citrate, citric acid, hydrochloric acid, tartaric acid, protease, and combinations thereof.

In a further aspect, the nutritional product is used for preventing, alleviating, and/or compensating swallowing dysfunction in a patient in need thereof.

In a further aspect, the nutritional product is used for promoting swallowing safety and/or efficiency of a nutritional product in a patient in need thereof.

In a further aspect, the nutritional product is used for mitigating a risk of aspiration during swallowing of a nutritional product in a patient in need thereof.

In another aspect, the present disclosure provides a thickener comprising a beta-glucan and a stabilizer comprising comprises at least one of Na₂HPO₄, sodium azide, potassium sorbate, sodium benzoate, sodium citrate, or protease.

In another aspect, the present disclosure provides a system for production of a stable homogenous single phase beverage for administration to an individual having dysphagia, the system comprising: a first container containing a thickener comprising a beta-glucan; a second container containing a stabilizer comprising comprises at least one of Na₂HPO₄, sodium azide, potassium sorbate, sodium benzoate, sodium citrate, or protease; a metering device connected to the container and configured to dispense a first amount of the thickener that is approximately equal to a first predetermined amount and a second amount of the stabilizer that is approximately equal to a second predetermined amount.

An advantage of one or more embodiments provided by the present disclosure is promoting both safer and more effective swallowing of boluses of a palatable nutritional product in an individual suffering from dysphagia.

Another advantage of one or more embodiments provided by the present disclosure is maintaining the cohesiveness of the nutritional product and thus extending the shelf life of the nutritional product. The inventors have discovered that several factors can impact the stability of cohesiveness of products for individuals with dysphagia that contain high molecular weight beta-glucan over time: for example, microorganisms, enzyme degradation, temperature, UHT conditions, pH, etc. These factors alone or in combination impact the degradation of the beta-glucan and thus its molecular weight (MW), which in turn affects the cohesiveness of the products containing the beta-glucan. For example, sterile products usually retain their cohesiveness longer than non-sterile products. Ultra-high-treatment (UHT) processing is usually used for sterilization and thus can be used to stabilize the products as long as the temperature is not so high as to destroy the cohesiveness. Mechanical stress, such as the shear stress during manufacturing can also break down the long-molecular chains of the beta-glucan and thereby destroy cohesiveness, and thus low-shear equipment should be used. The pH level (level of acidity) and enzymes can also affect the stability of the beta-glucan. Enzyme activity (even after sterilization) can also break the long-chains. Inhibiting the enzymes by denaturing them, for example, by using protease, can improve the stability of the beta-glucan.

Another advantage of one or more embodiments provided by the present disclosure is to improve the lives of a large and growing number of individuals who suffer from dysphagia.

Yet another advantage of one or more embodiments provided by the present disclosure is to support specific interventions (e.g., to promote oral health, help restore normal swallowing, or reinforce a swallow-safe bolus) that can enable individuals to eat orally instead of being tube fed and/or requiring PEG placement and experience the psycho-social aspects of nutritional products associated with general well-being while guarding against the potentially negative consequences that result from lack of adequate swallowing ability, and therefore, prevent social isolation.

Still another advantage of one or more embodiments provided by the present disclosure is to improve the intake of nutritional products by individuals who suffer from dysphagia and thus enable such individuals to swallow a wider variety of nutritional products safely and comfortably, which may lead to an overall healthier condition of the individual and prevent further health-related decline.

Furthermore, another advantage of one or more embodiments provided by the present disclosure is to provide natural cohesiveness that saliva typically provides to food boluses of nutritional products when being consumed by an individual. One or more embodiments of the present disclosure may provide even better cohesiveness than saliva.

Moreover, another advantage of one or more embodiments provided by the present disclosure is to modify rheological properties of a nutritional product to prevent bolus penetration and aspiration.

Another advantage of one or more embodiments provided by the present disclosure is a nutritional product having cohesiveness akin to saliva produced in the mouth and thus providing a more natural sensation to individuals who suffer from dysphagia.

Yet another advantage of one or more embodiments provided by the present disclosure is a nutritional product devoid of the thickened sensation from conventional thickeners because one or more embodiments provided by the present disclosure leave no residue in the mouth of the individuals who suffer from dysphagia. This advantage is particularly relevant for liquid products that are intended to maintain their thin liquid properties.

Still another advantage of one or more embodiments provided by the present disclosure is a nutritional product having organoleptic properties superior to known thickened nutritional products.

Furthermore, another advantage of one or more embodiments provided by the present disclosure is improved cohesiveness of food boluses to prevent a food bolus from being broken into smaller fragments which may enter the airway or leave unwanted residues in the oropharyngeal and/or esophageal tract during the swallowing process.

Moreover, another advantage of one or more embodiments provided by the present disclosure is reduction of swallowing effort for individuals who suffer from dysphagia.

Another advantage of one or more embodiments provided by the present disclosure is reduced risk of residue build-up in the oropharyngeal and/or esophageal tracts of a dysphagia patient.

Yet another advantage of one or more embodiments provided by the present disclosure is increased cohesiveness and improved nutritional intake for individuals who suffer from dysphagia by enabling the individuals to swallow a wider variety of food and beverage products safely and comfortably, e.g., by improving bolus integrity (“cohesiveness”) and thus lending confidence to the individuals who suffer from dysphagia that the individual is able to consume a wider range of products.

Still another advantage of one or more embodiments provided by the present disclosure is improved ability and efficiency to swallow and thus improved safety through reduced risk of pulmonary aspiration.

Furthermore, another advantage of one or more embodiments provided by the present disclosure is greater independence from feeding assistance and/or reduced length of time spent in feeding-assistance during meal consumption.

Additional features and advantages are described herein and will be apparent from the following Figures and Detailed Description.

### BRIEF DESCRIPTION OF THE FIGURES

FIG. 1 shows the viscosities and relaxation times at different times and different temperatures (refrigerated and ambient) of the samples listed in the tables in the figure.

FIG. 2 is a picture of samples in FIG. 1.

FIG. 3 is a table of samples including different preservatives prepared for investigation of the effect on microorganisms at different times and temperatures.

FIG. 4 shows the microbiological cultures in the control experiment.

FIG. 5 shows the microbiological cultures in the presence of sodium azide (NaN₃).

FIG. 6 shows the microbiological cultures in the presence of potassium sorbate.

FIG. 7 shows the microbiological cultures in the presence of sodium benzoate.

FIG. 8 shows the stringiness of oat extracts containing sodium azide and potassium sorbate after 2 weeks.

FIG. 9 is a list of acids of which the effect on microorganisms was investigated.

FIG. 10 shows the microbiological cultures in the presence of citric acid (pH 3.5).

FIG. 11 shows the microbiological cultures in the presence of tartaric acid (pH 2.6).

FIG. 12 shows the microbiological cultures in the presence of potassium sorbate and citric acid.

FIG. 13 shows the microbiological cultures in the presence of potassium sorbate and tartaric acid.

FIG. 14 shows the microbiological cultures in the presence of sodium benzoate and citric acid.

FIG. 15 shows the microbiological cultures in the presence of sodium benzoate and tartaric acid.

FIG. 16 shows stringiness of the samples: 1: NaN3 after 14 days: 2: 2% oat extract after 14 days at room temperature; and 3: 2% oat extract at 4° C.

FIG. 17 shows the retention times using size exclusion chromatography for (a) 2% oat extract with NaN₃ after 2 weeks at 25° C. (the blue line) and (b) 2% oat extract after 2 weeks at 25° C. (the red line).

FIG. 18 shows the retention times of the standard β-glucan samples.

FIG. 19 shows the molecular weight of the samples in FIG. 36.

FIG. 20 shows the retention times using size exclusion chromatography of (a) 2% oat extract with NaN₃ after 2 weeks at 25° C., MW=1749846 (the blue line) and (b) 2% oat extract after 2 weeks at 25° C., MW=1106623 (the red line).

FIG. 21 shows the reaction between β-glucan and H+ from the Na₂HPO₄ additive.

FIG. 22 shows the list of samples used and their pH values.

FIG. 23 shows the retention times using size exclusion chromatography of (a) 2% oat extract at 25° C. with NaN₃, time=0) (the blue line), (b) 2% oat extract at 25° C. with NaN₃ and Na₂HPO₄ 0.01% time=0) (the red line), and (c) 2% oat extract at 25° C. with NaN₃ and Na₂HPO₄ 0.1% time=0) (the green line).

FIG. 24 shows the retention times using size exclusion chromatography of (a) 2% oat extract at 25° C. with NaN₃, time=30 days, (b) 2% oat extract at 25° C. with NaN₃ and Na₂HPO₄ 0.01% time=30 days, and (c) 2% oat extract at 25° C. with NaN₃ and Na₂HPO₄ 0.1% time=30 days.

FIG. 25 shows the cohesiveness of the samples containing Na₂HPO₄: I. 2% oat extract at 25° C. with NaN₃, time=35 days: II. 2% oat extract at 25° C. with NaN₃ and Na₂HPO₄ 0.01% time=35 days; and III. 2% oat extract at 25° C. with NaN₃ and Na₂HPO₄ 0.1% time=35 days.

FIG. 26 shows the retention times using size exclusion chromatography of (a) 2% oat extract at 25° C., NaN₃+Thiosulfate 0.01%, time=0) (the blue line), (b) 2% oat extract at 25° C., NaN₃+Thiosulfate 0.05%, time=0) (the red line), and (c) 2% oat extract at 25° C., NaN₃+Thiosulfate 0.10%, time=0) (the green line).

FIG. 27 shows the retention times using size exclusion chromatography of (a) 2% oat extract at 25° C., NaN₃+Thiosulfate 0.01% after 26 days (the blue line), (b) 2% oat extract at 25° C., NaN₃+Thiosulfate 0.05% after 26 days (the red line), and (c) 2% oat extract at 25° C., NaN₃+Thiosulfate 0.10% after 26 days (the green line).

FIG. 28 shows cohesiveness of the solutions containing the thiosulfate: I. 2% oat extract at 25° C., NaN₃ after 30 days: II. 2% oat extract at 25° C., NaN₃+Thiosulfate 0.01% after 26 days: III. 2% oat extract at 25° C., NaN₃+Thiosulfate 0.05% after 26 days: IV. 2% oat extract at 25° C., NaN₃+Thiosulfate 0.10% after 26 day's

FIG. 29 shows the retention times using size exclusion chromatography of (a) 2% oat extract at 25° C., 500 rpm 20 h, Under N₂ (the top panel) and (b) 2% oat extract at 25° C., 500 rpm 20 h, Under O₂ (the bottom panel).

FIG. 30 shows the retention times using size exclusion chromatography of (a) 2% oat extract at 25° C., no rpm, 48 h (the blue line), (b) 2% oat extract at 25° C., 500 rpm 48 h, Under N₂ (the red line), and (c) 2% oat extract at 25° C., 500 rpm 48 h, Under O₂ (the green line).

FIG. 31 shows the retention times using size exclusion chromatography of (a) 2% oat extract with NaN₃ at 25° C. after 21 days, no rpm, N₂ (the blue line) and (b) 2% oat extract with NaN₃ at 25° C. after 21 days, no rpm, O₂ (the red line).

FIG. 32 shows the retention times using size exclusion chromatography of (a) 2% oat extract at 25° C., NaN₃+Protease 0.01% t=0 (the blue line), (b) 2% oat extract at 25° C., NaN₃+Protease 0.10% t=0 (the red line), and (c) 2% oat extract at 25° C., NaN₃+Protease 0.20% t=0 (the green line).

FIG. 33 shows the retention times using size exclusion chromatography of (a) 2% oat extract at 25° C., NaN₃+Protease 0.01% after 10 days (the blue line), (b) 2% oat extract at 25° C., NaN₃+Protease 0.10% after 10 days (the red line), and (c) 2% oat extract at 25° C., NaN₃+Protease 0.20% after 10 days.

FIG. 34 shows the cohesiveness of the solutions containing protease: I. 2% oat extract at 25° C., NaN₃ after 10 days; II. 2% oat extract at 25° C., NaN₃+Protease 0.01% after 10 days; III. 2% oat extract at 25° C., NaN₃+Protease 0.10% after 10 days; IV. 2% oat extract at 25° C., NaN₃+Protease 0.20% after 10 days.

FIG. 35 shows the Glucanase temperature activity profile.

FIG. 36 shows the Glucanase pH activity profile.

FIG. 37 shows the retention times using size exclusion chromatography of (a) 2% oat extract at 25° C., NaN₃+25° C. hold time=15 min, t=0) (the blue line), (b) 2% oat extract at 25° C., NaN₃+80° C. hold time=15 min, t=0 (the red line), (c) 2% oat extract at 25° C., NaN₃+90° C. hold time=15 min, t=0 (the green line), and (d) 2% oat extract at 25° C., NaN₃+100° C. hold time=15 min, t=0) (the pink line).

FIG. 38 shows the retention times using size exclusion chromatography of (a) 2% oat extract at 25° C., NaN₃+25° C. after 10 days (the blue line), (b) 2% oat extract at 25° C., NaN₃+80° C. after 10 days (the red line), (c) 2% oat extract at 25° C., NaN₃+90° C. after 10 days (the green line), and (d) 2% oat extract at 25° C., NaN₃+100° C. after 10 days (the pink line).

FIG. 39 shows the cohesiveness of the solutions: I. 2% oat extract at 25° C., NaN₃+25° C. after 15 days: II. 2% oat extract at 25° C., NaN₃+80° C. after 15 days: III. 2% oat extract at 25° C., NaN₃+90° C. after 15 days: IV. 2% oat extract at 25° C., NaN₃+100° C. after 15 days.

FIG. 40 shows the retention times using size exclusion chromatography of (a) 2% oat extract at 25° C., NaN₃+5 sec microwave heating 700 W, time=0) (the blue line), (b) 2% oat extract at 25° C., NaN₃+10 sec microwave heating 700 W, time=0 (the red line), (c) 2% oat extract at 25° C., NaN₃+15 sec microwave heating 700 W, time=0) (the green line), and (d) 2% oat extract at 25° C., NaN₃+2×15 sec microwave heating 700 W, time=0) (the pink line).

FIG. 41 shows the retention times using size exclusion chromatography of (a) 2% oat extract at 25° C., NaN₃+5 sec microwave heating 700 W, after 10 days (the blue line), (b) 2% oat extract at 25° C., NaN₃+10 sec microwave heating 700 W, after 10 days (the red line), (c) 2% oat extract at 25° C., NaN₃+15 sec microwave heating 700 W, after 10 days (the green line), and (d) 2% oat extract at 25° C., NaN₃+2×15 sec microwave heating 700 W, after 10 days (the pink line).

FIG. 42 shows the cohesiveness of the solutions: I. 2% oat extract at 25° C., NaN₃+5 sec microwave heating after 15 days: II. 2% oat extract at 25° C., NaN₃+10 sec microwave heating after 15 days: III. 2% oat extract at 25° C., NaN₃+15 sec microwave heating after 15 days.

FIG. 43 shows the retention times using size exclusion chromatography of (a) 2% oat extract at 25° C., 5 sec microwave heating 700 W, time=0 (the blue line), (b) 2% oat extract at 25° C., 10 sec microwave heating 700 W, time=0 (the red line), and (c) 2% oat extract at 25° C., 15 sec microwave heating 700 W, time=0 (the green line).

FIG. 44 shows the retention times using size exclusion chromatography of (a) 2% oat extract at 25° C., 5 sec microwave heating 700 W, after 10 days (the blue line), (b) 2% oat extract at 25° C., 10 sec microwave heating 700 W, after 10 days (the red line), and (c) 2% oat extract at 25° C., 15 sec microwave heating 700 W, after 10 days (the green line).

### DETAILED DESCRIPTION

The various aspects and embodiments according to the present disclosure, as set forth herein, are illustrative of the specific ways to make and use the invention and do not limit the scope of invention when taken into consideration with the claims and the detailed description. It will also be appreciated that features from aspects and embodiments of the invention may be combined with further features from the same or different aspects and embodiments of the invention.

As used in this detailed description and the appended claims, the singular forms “a,” “an” and “the” include plural referents unless the context clearly dictates otherwise. For example, reference to “an ingredient” or “a method” includes a plurality of such “ingredients” or “methods.” The term “and/or” used in the context of “X and/or Y” should be interpreted as “X,” or “Y,” or “X and Y.” Similarly, “at least one of X or Y” should be interpreted as “X,” or “Y,” or “both X and Y.” Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” is also a disclosure of embodiments “consisting essentially of” and “consisting of” the disclosed components. “Consisting essentially of” means that the embodiment or component thereof comprises more than 50 wt. % of the individually identified components, preferably at least 75 wt. % of the individually identified components, more preferably at least 85 wt. % of the individually identified components, most preferably at least 95 wt. % of the individually identified components, for example at least 99 wt. % of the individually identified components.

All ranges described are intended to include all numbers, whole or fractions, contained within the said range. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth. As used herein, wt. % refers to the weight of a particular component relative to total weight of the referenced composition.

In one aspect, the physical stability, especially with regards to rheological and in particular cohesive properties of a nutritional product may be enhanced by reducing and/or preventing growth of microorganisms in the nutritional product; and/or deactivating enzymes in the nutritional product; and/or preventing hydrolysis of the beta-glucan in the nutritional product. The nutritional product may contain a beta-glucan. The nutritional product may be consumed in liquid form.

A stabilizer may be added to the nutritional product. The stabilizer may comprise at least one of Na₂HPO₄, sodium azide, potassium sorbate, sodium benzoate, sodium citrate, citric acid, hydrochloric acid, tartaric acid, or protease. In one embodiment, the stabilizer may comprise at least one of Na₂HPO₄ or sodium azide. For example, the stabilizer may comprise Na₂HPO₄. In another embodiment, the stabilizer may comprise at least one of sodium azide or protease. When a protease is added to the nutritional product, the concentration of protease added can be below 0.2 wt % of the nutritional product. In another embodiment, the stabilizer may comprise sodium benzoate and citric acid. In yet another embodiment, the stabilizer may comprise potassium sorbate and tartaric acid.

The nutritional product may be heated to a temperature between about 30° C. and about 100° C., for example, between about 40° C. and about 90° C., between about 50° C. and about 80° C., or between about 60° C. and about 70° C.

The heat treatment of the nutritional product may be carried out by microwave heating or any other suitable heat treatment.

In one embodiment, tartaric acid may be added to the nutritional product, and the nutritional product may also be subject to heat treatment, such as microwave heating.

In one embodiment, sodium azide may be added to the nutritional product, and the nutritional product may also be subject to heat treatment, such as microwave heating.

When the nutritional product is subject to microwave heating, the microwave heating can be from about 1 second to 1 minute, for example, from about 1 to about 30 seconds, from about 5 to about 25 seconds, from about 5 to about 20 seconds, from about 5 to about 15 seconds, or about 10 seconds.

The pH of the nutritional product can be adjusted to from about 3 to about 7, for example, from about 3 to about 6.5, from about 3.5 to about 6, from about 4 to about 5.5, from about 4.5 to about 5, from about 3 to about 4, from about 4 to about 5, from about 5 to about 6, from about 6 to about 7, about 3, about 4, about 5, about 6, or about 7.

In a further aspect, degradation of a beta-glucan in a nutritional product comprising the beta-glucan may be prevented by a treatment such as, adding to the nutritional product a stabilizer selected from the group consisting of Na₂HPO₄, sodium azide, potassium sorbate, sodium benzoate, sodium citrate, citric acid, hydrochloric acid, tartaric acid, protease, and combinations thereof; and/or heating the nutritional product to a temperature between about 30° C. and about 100° C.; and/or adjusting a pH of the nutritional product to from about 3 to about 7.

In one embodiment, the stabilizer may comprise at least one of Na₂HPO₄ or sodium azide. For example, the stabilizer may comprise Na₂HPO₄. In another embodiment, the stabilizer may comprise at least one of sodium azide or protease. When a protease is added to the nutritional product, the concentration of protease added can be below 0.2 wt % of the nutritional product. In another embodiment, the stabilizer may comprise sodium benzoate and citric acid. In yet another embodiment, the stabilizer may comprise potassium sorbate and tartaric acid.

The nutritional product may be heated to a temperature between about 30° C. and about 100° C., for example, between about 40° C. and about 90° C., between about 50° C. and about 80° C., or between about 60° C. and about 70° C.

The heat treatment of the nutritional product may be carried out by microwave heating or any other suitable heat treatment.

In one embodiment, tartaric acid may be added to the nutritional product, and the nutritional product may also be subject to heat treatment, such as microwave heating.

In one embodiment, sodium azide may be added to the nutritional product, and the nutritional product may also be subject to heat treatment, such as microwave heating.

When the nutritional product is subject to microwave heating, the microwave heating can be from about 1 second to 1 minute, for example, from about 1 to about 30 seconds, from about 5 to about 25 seconds, from about 5 to about 20 seconds, from about 5 to about 15 seconds, or about 10 seconds.

The pH of the nutritional product can be adjusted to from about 3 to about 7, for example, from about 3 to about 6.5, from about 3.5 to about 6, from about 4 to about 5.5, from about 4.5 to about 5, from about 3 to about 4, from about 4 to about 5, from about 5 to about 6, from about 6 to about 7, about 3, about 4, about 5, about 6, or about 7.

In a further aspect, a method for making a nutritional product may comprise diluting a thickener comprising a beta-glucan in a diluent into the nutritional product.

In some embodiments, the method may further comprise adding a stabilizer to the nutritional product. The stabilizer may comprise at least one of Na₂HPO₄, sodium azide, potassium sorbate, sodium benzoate, sodium citrate, citric acid, hydrochloric acid, tartaric acid, or protease. In one embodiment, the stabilizer may comprise at least one of Na₂HPO₄ or sodium azide. For example, the stabilizer may comprise Na₂HPO₄. In another embodiment, the stabilizer may comprise at least one of sodium azide or protease. When a protease is added to the nutritional product, the concentration of protease added can be below 0.2 wt % of the nutritional product. In another embodiment, the stabilizer may comprise sodium benzoate and citric acid. In yet another embodiment, the stabilizer may comprise potassium sorbate and tartaric acid.

In some embodiments, the method may further comprise heating the nutritional product. Heating can denature microorganisms in the nutritional product and thus prevent degradation of the beta-glucan and preserve the cohesiveness of the nutritional product. The nutritional product can be heated, preferably rapidly, to a temperature between about 30° C. and about 100° C., for example, between about 40° C. and about 90° C., between about 50° C. and about 80° C., or between about 60° C. and about 70° C.

In some embodiments, the nutritional product can be subject to heat treatment, such as microwave heating, for example, from about 1 second to 1 minute, for example, from about 1 to about 30 seconds, from about 5 to about 25 seconds, from about 5 to about 20 seconds, from about 5 to about 15 seconds, or about 10 seconds.

In some embodiments, the method can comprise at least one of adding NaN₃ or microwave heating the nutritional product, preferably, both adding sodium azide and microwave heating the nutritional product, for example, for about 10 seconds. In some embodiments, the method can comprise at least one of adding tartaric acid or heating the nutritional product, preferably, both adding tartaric acid or heating the nutritional product, for example, to a temperature between about 30° C. and about 100° C., for example, between about 40° C. and about 90° C., between about 50° C. and about 80° C., or between about 60° C. and about 70° C.

In some embodiments, the method may further comprise adjusting the pH of the nutritional product to, for example, from about 3 to about 7, preferably from about 4 to about 7 or from about 5 to about 7, more preferably from about 6 to about 7, and even more preferably about 7. Basic media can deactivate enzymes and prevent hydrolysis of the beta-glucan.

In another further aspect, a nutritional product may comprise a beta-glucan and a stabilizer selected from the group consisting of Na₂HPO₄, sodium azide, potassium sorbate, sodium benzoate, sodium citrate, citric acid, hydrochloric acid, tartaric acid, protease, and combinations thereof. In one embodiment, the stabilizer may comprise at least one of Na₂HPO₄ or sodium azide. For example, the stabilizer may comprise Na₂HPO₄ which can prevent the degradation of the beta-glucan. In another embodiment, the stabilizer may comprise at least one of sodium azide or protease. The use of protease can also improve the desired stability of the beta-glucan through enzyme degradation. When the stabilizer includes a protease, the concentration of the protease may be below 0.2 wt % of the nutritional product. In another embodiment, the stabilizer may comprise sodium benzoate and citric acid. The stabilizer can comprise at least one of Na₂HPO₄ or Glucanase. In yet another embodiment, the stabilizer may comprise potassium sorbate and tartaric acid.

The nutritional product may have pH from about 3 to about 7, preferably from about 4 to about 7 or from about 5 to about 7, more preferably from about 6 to about 7, and even more preferably about 7.

In a further aspect, a thickener may comprise a beta-glucan and an additive. The additive and the beta-glucan may have a weight ratio of up to about 1:1, for example, from about 10:1 to about 1:1. The additive may comprise a protein and/or a gum and/or a stabilizer. The thickener is formulated for dilution in a diluent to form a nutritional product. In one embodiment, the stabilizer may comprise at least one of Na₂HPO₄ or sodium azide. For example, the stabilizer may comprise Na₂HPO₄. In another embodiment, the stabilizer may comprise at least one of sodium azide or protease. When the stabilizer includes a protease, the concentration of the protease may be below 0.2 wt % of the nutritional product. In another embodiment, the stabilizer may comprise sodium benzoate and citric acid. In yet another embodiment, the stabilizer may comprise potassium sorbate and tartaric acid. The stabilizer comprising comprises at least one of Na₂HPO₄, sodium azide, potassium sorbate, sodium benzoate, sodium citrate, or protease.

The thickener can be a power or a liquid concentrate of the powder. As used herein, a “powder” is a solid that is formulated to be diluted before administration. Further in this regard, the powders disclosed herein are only administered after addition of another ingredient, such as a liquid diluent, preferably water. A “liquid concentrate” is a liquid that is formulated to be diluted before administration. Further in this regard, the liquid concentrates disclosed herein are only administered after addition of another ingredient, such as a liquid diluent, preferably water.

As used herein, the term “nutritional product” refers to a nutritional composition for oral administration by an individual who suffers from dysphagia. The nutritional product is envisaged for supplemental nutrition, for hydration, or for replacement of one or more full meals of the individual who suffers from dysphagia. The nutritional product is also understood to include any number of optional ingredients (e.g., ingredients additional to the liquid concentrate from which the nutritional product is made). Non-limiting examples of suitable optional ingredients include conventional food additives, for example one or more, acidulants, additional thickeners, buffers or agents for pH adjustment, chelating agents, colorants, emulsifiers, excipient, flavour agent, minerals, osmotic agents, a pharmaceutically acceptable carrier, preservatives, stabilisers, sugar(s), sweetener(s), texturiser(s), and/or vitamin(s). The optional ingredients can be added in any suitable amount. Preferably, the liquid concentrate is a homogeneous single phase liquid comprising water, and preferably the nutritional product is a homogeneous single phase beverage comprising water. Nevertheless, the present disclosure is not limited to a specific embodiment of the nutritional product. Furthermore, the present disclosure is not limited to a specific embodiment of the diluent in which the liquid concentrate is reconstituted, and the diluent can be any liquid suitable for consumption by an animal or human.

A “ready to drink” beverage or “RTD” beverage is a beverage in liquid form that can be consumed without further addition of liquid. Preferably an RTD beverage is aseptic. An “oral nutrition supplement” or “ONS” is a composition comprising at least one macronutrient and/or at least one micro nutrient, for example in a form of sterile liquids, semi-solids or powders, and intended to supplement other nutritional intake such as that from food. Non-limiting examples of commercially available ONS products include, for example, MERITENE®, BOOST®, NUTREN® SUSTAGEN®, RESOURCE®, and CLINUTREN®. The term “unit dosage form,” as used herein, refers to physically discrete units suitable as unitary dosages for human and animal subjects, each unit containing a predetermined quantity of the composition disclosed herein in an amount sufficient to produce the desired effect, preferably in association with a pharmaceutically acceptable diluent, carrier or vehicle. The specifications for the unit dosage form depend on the particular compounds employed, the effect to be achieved, and the pharmacodynamics associated with each compound in the host. In an embodiment, the unit dosage form can be a predetermined amount of liquid concentrate dispensed by a dispenser or housed within a container such as a pouch.

The term individual refers to any human, animal, mammal or who suffers from dysphagia that can benefit from the nutritional product. It is to be appreciated that animal includes, but is not limited to, mammals. Mammal includes, but is not limited to, rodents, aquatic mammals, domestic animals such as dogs and cats, farm animals such as sheep, pigs, cows and horses, and humans.

As used herein, an “effective amount” is an amount that prevents a deficiency, treats a disease or medical condition in an individual or, more generally, reduces symptoms, manages progression of the diseases or provides a nutritional, physiological, or medical benefit to the individual. The relative terms “promote,” “improve,” “increase,” “enhance” and the like refer to the effects of a nutritional product comprising the thickener disclosed herein relative to a nutritional product lacking the thickener, but otherwise identical.

As used herein, a beta-glucan (β-glucan) refers to homopolysaccharides of D-glucopyranose monomers linked by (1→3), (1→4)-β-glycosidic bonds. A beta-glucan is derivable from plant or microbial origin, e.g. from oat or barley, by methods known to the skilled person, for example as described by Lazaridou et al. in ‘A comparative study on structure-function relations of mixed-linkage (1→3), (1→4) linear β-D-glucans’ in Food Hydrocolloids, 18 (2004), 837-855. The beta-glucan may have a molecular weight (MW) above about 1,200,000 Da, for example, from about 1,200,000 Da to about 2,500,000 Da, preferably, from about 1,200,000 Da to about 1,500,000 Da, from about 1,200,000 Da to about 1,800,000 Da, from about 1,200,000 Da to about 1,900,000 Da, from about 1,200,000 Da to about 2,000,000 Da, more preferably from about 1,500,000 Da to about 1,800,000 Da, from about 1,500,000 Da to about 1,900,000 Da, from about 1,500,000 Da to about 2,000,000 Da, from about 1,500,000 Da to about 2,100,000 Da, even more preferably about 1,800,000 Da to about 1,900,000 Da, from about 1,800,000 Da to about 2,000,000 Da, from about 1,800,000 Da to about 2,100,000 Da, from about 1,900,000 Da to about 2,000,000 Da, from about 1,900,000 Da to about 2,500,000 Da, from about 2,000,000 Da to about 2,500,000 Da. The beta-glucan having a MW from about 1,200,000 Da to about 1,600,000 Da can be non-cohesive, and the beta-glucan having a MW from about 1,800,000 Da to about 2,500,000 Da can be cohesive, as measured by their relaxation times.

Additionally to the beta-glucan, the thickener may comprise a gum selected from the group consisting of konjac mannan, tara gum, locust bean gum, guar gum, fenugreek gum, tamarind gum, cassia gum, acacia gum, gum ghatti, pectins, cellulosics, tragacanth gum, karaya gum, and combinations thereof; and/or a plant-derived mucilages selected from the group consisting of cactus mucilage, psyllium mucilage, mallow mucilage, flax seed mucilage, marshmallow mucilage, ribwort mucilage, mullein mucilage, cetraria mucilage, and combinations thereof.

In some embodiments, the liquid nutritional product may have a total solids content up to 1%, preferably from about 0.2% to about 0.75%, for example, from about 0.2% to about 0.3%, from about 0.2% to about 0.5%, from about 0.3% to about 0.5%, from about 0.3% to about 0.75%, from about 0.5% to about 0.75%, and about 0.75%. As used herein, the total solids content is measured by assuming 100% dry matter of powder (no moisture). For example, a liquid obtained by dissolving about 0.03 g dry powder (no moisture) in about 4 grams of water would have a total solids content of about 0.75%.

As used herein, the feature “bolus” includes any entity of the nutritional product formed in the mouth in preparation for swallowing. The bolus may be of any shape, size, composition and/or texture, and thus it may also be a liquid.

A shear flow is a flow of a solution in which parallel planes are displaced in a direction parallel to each other. Shear viscosity is a measurable rheological property. Shear viscosity, often referred to as viscosity, describes the action of a material to applied shear stress. In other words, shear stress is the ratio between “stress” (force per unit area) exerted on the surface of a fluid, in the lateral or horizontal direction, to the change in velocity of the fluid as you move down in the fluid (a “velocity gradient”). Shear viscosity of a nutritional product can be determined by any method that can accurately control the shear rate applied to the product and simultaneously determine the shear stress or vice versa. Often used are rheometers which generally impose a specific stress field or deformation to the fluid and monitor the resultant deformation or stress. These instruments may operate in steady flow or oscillatory flow, as well as shear. Standard methods include the use of concentric cylinders, cone-and-plate and plate-plate geometries.

Another rheological property of a material is its extensional viscosity. An extensional flow is the behavior of a solution to resist extension and return to a coil structure while being squeezed or pulled. Extensional viscosity is the ratio of the stress required to extend a liquid in its flow direction to the extension rate. Extensional viscosity coefficients are widely used for characterising polymers, where they cannot be simply calculated or estimated from the shear viscosity.

Extensional viscosity is often measured by the relaxation time determined using the Capillary Breakup Extensional Rheometer (CaBER), which is an example for a rheometer applying extensional stress. During the CaBER experiment as performed herein for measuring the relaxation time of the nutritional product, a drop of said product is placed between two vertically aligned and parallel circular metal surfaces, both having a diameter of 6 mm. The metal surfaces are then rapidly separated linearly over a time interval of 50 ms. The filament formed by this stretching action subsequently thins under the action of interfacial tension and the thinning process is followed quantitatively using a digital camera and/or laser sheet measuring the filament diameter at its mid-point. The relaxation time in a CaBER experiment is determined by plotting the normalised natural logarithm of the filament diameter during the thinning process versus time and determining the slope of the linear portion (dₗₙ (D/D₀)/dₜ) of this curve, where D is the filament diameter, D₀ the filament diameter at time zero and t the time of filament thinning. The relaxation time in this context is then defined as minus one third (−⅓) times the inverse of this slope, i.e. −1/(3dₗₙ(D/D₀)/dₜ).

The cohesion or cohesiveness of a nutritional product or a bolus thereof is the ability of the nutritional product or the bolus thereof to bind and stay together in the oral cavity and through the swallowing process. It may be measured by the “stringiness” of the nutritional product or the bolus thereof, which is a proxy of and directly related to the relaxation time. It is preferred that in the present nutritional product, the relaxation time is from 10 ms to 2000 ms, preferably from 20 ms to 1000 ms, likewise preferably from 50 ms to 450 ms, from 100 ms to 2000 ms, from 100 ms to 450 ms, and more preferably from 400 ms to 2000 ms, from 400 ms to 450 ms, each at a temperature of 20° C.

Moreover, in a preferred embodiment, a filament diameter of the nutritional product decreases less than linearly, and preferably exponentially in time during the CaBER experiment. The filament diameter can be measured using a digital camera and/or laser sheet measuring device.

In some embodiments, the nutritional product may further comprise a diluent to dissolve the thickener. The diluent can be one or more of water, milk, a beverage comprising water and further comprising at least one component additional to the water, a liquid oral nutritional supplement (ONS), or a food product. The dilution of the thickener in the diluent directly forms the nutritional product such that the nutritional product consists essentially of or consists of the diluent and the thickener. In some embodiments, the dilution of the thickener in the diluent forms an aqueous solution followed by addition of the aqueous solution to at least one other orally administrable composition to form the nutritional product, such that the nutritional product consists essentially of or consists of the diluent, the thickener, and the at least one other orally administrable composition. In some embodiments, the nutritional product is a ready-to-drink beverage.

In some embodiments, the nutritional product is in a unit dosage form comprising an amount of the thickening component effective for administration of the nutritional product to an individual who suffers from dysphagia to achieve at least one of (i) supplemental nutrition, (ii) hydration and (ii) replacement of one or more full meals.

The nutritional product may furthermore comprise one or more of a protein, a fat, a fiber, a carbohydrate, a prebiotic, a probiotic, an amino acid, a fatty acid, a phytonutrient, an antioxidant, and/or combinations thereof.

The protein can be a dairy-based protein, a plant-based protein or an animal-based protein or any combination thereof. Dairy-based proteins include, for example, casein, caseinates (e.g., all forms including sodium, calcium, potassium caseinates), casein hydrolysates, whey (e.g., all forms including concentrate, isolate, demineralized), whey hydrolysates, milk protein concentrate, and milk protein isolate. Plant-based proteins include, for example, soy protein (e.g., all forms including concentrate and isolate), pea protein (e.g., all forms including concentrate and isolate), canola protein (e.g., all forms including concentrate and isolate), other plant proteins that commercially are wheat and fractionated wheat proteins, corn and it fractions including zein, rice, oat, potato, peanut, green pea powder, green bean powder, and any proteins derived from beans, lentils, and pulses. Animal-based proteins may be selected from the group consisting of beef, poultry, fish, lamb, seafood, or combinations thereof. Preferably, the protein is at least one of rice protein or lentil protein.

The fat can be vegetable fat (such as olive oil, corn oil, sunflower oil, rapeseed oil, hazelnut oil, soy oil, palm oil, coconut oil, canola oil, lecithins, and the like), animal fat (such as milk fat) or any combinations thereof.

The fiber can be a fiber blend that may contain a mixture of soluble and insoluble fiber. Soluble fibers may include, for example, fructooligosaccharides, acacia gum, inulin, and the like. Insoluble fibers may include, for example, pea outer fiber.

The carbohydrate can comprise sucrose, lactose, glucose, fructose, corn syrup solids, maltodextrin, modified starch, amylose starch, tapioca starch, corn starch or any combinations thereof.

The nutritional product can comprise at least one the following prebiotics or any combination thereof: acacia gum, alpha glucan, arabinogalactans, dextrans, fructooligosaccharides, fucosyllactose, galactooligosaccharides, galactomannans, gentiooligosaccharides, glucooligosaccharides, guar gum, inulin, isomalto-oligosaccharides, lactoneotetraose, lactosucrose, lactulose, levan, maltodextrins, milk oligosaccharides, partially hydrolyzed guar gum, pecticoligosaccharides, resistant starches, retrograded starch, sialooligosaccharides, sialyllactose, soyoligosaccharides, sugar alcohols, xylooligosaccharides, or their hydrolysates, or combinations thereof. The prebiotic is a food substance that selectively promotes the growth of beneficial bacteria or inhibits the growth or mucosal adhesion of pathogenic bacteria in the intestines. The prebiotic are not inactivated in the stomach and/or upper intestine or absorbed in the gastrointestinal tract of the individual ingesting them, but they are fermented by the gastrointestinal microflora and/or by probiotics. Prebiotics are, for example, defined by Glenn R. Gibson and Marcel B. Roberfroid, Dietary Modulation of the Human Colonic Microbiota: Introducing the Concept of Prebiotics, J. Nutr. 1995 125: 1401-1412.

The nutritional product can comprise at least one probiotic. Probiotics are food-grade microorganisms (alive, including semi-viable or weakened, and/or non-replicating), metabolites, microbial cell preparations or components of microbial cells that could confer health benefits on a host when administered, more specifically probiotics beneficially affect the host by improving intestinal microbial balance, leading to effects on the health or well-being of the host. See, Salminen S, Ouwehand A. Benno Y. et al., Probiotics: how should they be defined?, Trends Food Sci. Technol. 1999:10, 107-10. In general, it is believed that these probiotics inhibit or influence the growth and/or metabolism of pathogenic bacteria in the intestinal tract. The probiotics may also activate the immune function of the host. The probiotics may include Aerococcus, Aspergillus, Bacillus, Bacteroides, Bifidobacterium, Candida, Clostridium, Debaromyces, Enterococcus, Fusobacterium, Lactobacillus, Lactococcus, Leuconostoc, Melissococcus, Micrococcus, Mucor, Oenococcus, Pediococcus, Penicillium, Peptostrepococcus, Pichia, Propionibacterium, Pseudocatenulatum, Rhizopus, Saccharomyces, Staphylococcus, Streptococcus, Torulopsis, Weissella, or any combination thereof.

The nutritional product may comprise a synbiotic. A synbiotic is a supplement that comprises both a prebiotic (at least one of the aforementioned) and a probiotic (at least one of the aforementioned) that work together to improve the microflora of the intestine.

The nutritional product can comprise at least one the following amino acids or any combination thereof: alanine, arginine, asparagine, aspartate, citrulline, cysteine, glutamate, glutamine, glycine, histidine, hydroxyproline, hydroxyserine, hydroxytyrosine, hydroxylysine, isoleucine, leucine, lysine, methionine, phenylalanine, proline, serine, taurine, threonine, tryptophan, tyrosine and valine.

In a further embodiment, the nutritional product can comprise at least one fatty acid or any combination thereof, for example ω-3 fatty acids such α-linolenic acid (“ALA”), docosahexaenoic acid (“DHA”) and eicosapentaenoic acid (“EPA”). The fatty acid can be derived from fish oil, krill, poultry, eggs, a plant source, algae and/or a nut source, e.g., flax seed, walnuts, almonds.

The nutritional product can comprise at least one phytonutrient. The phytonutrient can be at least one of flavanoids, allied phenolic compounds, polyphenolic compounds, terpenoids, alkaloids, or sulphur-containing compounds. Phytonutrients are non-nutritive compounds that are found in many foods. Phytonutrients are functional foods that have health benefits beyond basic nutrition, and are health promoting compounds that come from plant sources. Phytonutrient refers to any chemical produced by a plant that imparts one or more health benefit on a user. Non-limiting examples of suitable phytonutrients include:
i) phenolic compounds which include monophenols (such as, for example, apiole, carnosol, carvacrol, dillapiole, rosemarinol); flavonoids (polyphenols) including flavonols (such as, for example, quercetin, fingerol, kaempferol, myricetin, rutin, isorhamnetin), flavanones (such as, for example, fesperidin, naringenin, silybin, eriodictyol), flavones (such as, for example, apigenin, tangeritin, luteolin), flavan-3-ols (such as, for example, catechins, (+)-catechin, (+)-gallocatechin, (−)-epicatechin, (−)-epigallocatechin, (−)-epigallocatechin gallate (EGCG), (−)-epicatechin 3-gallate, theaflavin, theaflavin-3-gallate, theaflavin-3′-gallate, theaflavin-3,3′-digallate, thearubigins), anthocyanins (flavonals) and anthocyanidins (such as, for example, pelargonidin, peonidin, cyanidin, delphinidin, malvidin, petunidin), isoflavones (phytoestrogens) (such as, for example, daidzein (formononetin), genistein (biochanin A), glycitein), dihydroflavonols, chalcones, coumestans (phytoestrogens), and Coumestrol; Phenolic acids (such as: Ellagic acid, Gallic acid, Tannic acid, Vanillin, curcumin); hydroxycinnamic acids (such as, for example, caffeic acid, chlorogenic acid, cinnamic acid, ferulic acid, coumarin); lignans (phytoestrogens), silymarin, secoisolariciresinol, pinoresinol and lariciresinol); tyrosol esters (such as, for example, tyrosol, hydroxytyrosol, oleocanthal, oleuropein); stilbenoids (such as, for example, resveratrol, pterostilbene, piceatannol) and punicalagins.
ii) terpenes (isoprenoids) which include carotenoids (tetraterpenoids) including carotenes (such as, for example, α-carotene, β-carotene, γ-carotene, δ-carotene, lycopene, neurosporene, phytofluene, phytoene), and xanthophylls (such as, for example, canthaxanthin, cryptoxanthin, aeaxanthin, astaxanthin, lutein, rubixanthin); monoterpenes (such as, for example, limonene, perillyl alcohol); saponins; lipids including: phytosterols (such as, for example, campesterol, beta-sitosterol, gamma-sitosterol, stigmasterol), tocopherols (vitamin E), and γ-3, γ-6, and γ-9 fatty acids (such as, for example, gamma-linolenic acid); triterpenoid (such as, for example, oleanolic acid, ursolic acid, betulinic acid, moronic acid).
iii) betalains which include Betacyanins (such as: betanin, isobetanin, probetanin, neobetanin); and betaxanthins (non glycosidic versions) (such as, for example, indicaxanthin, and vulgaxanthin).
iv) organosulfides, which include, for example, dithiolthiones (isothiocyanates) (such as, for example, sulphoraphane); and thiosulphonates (allium compounds) (such as, for example, allyl methyl trisulfide, and diallyl sulfide), indoles, glucosinolates, which include, for example, indole-3-carbinol; sulforaphane; 3,3′-diindolylmethane; sinigrin; allicin; alliin; allyl isothiocyanate; piperine; syn-propanethial-S-oxide.
v) protein inhibitors, which include, for example, protease inhibitors.
vi) other organic acids which include oxalic acid, phytic acid (inositol hexaphosphate); tartaric acid; and anacardic acid.

The nutritional product can comprise at least one antioxidant. Antioxidants are molecules capable of slowing or preventing the oxidation of other molecules. The antioxidant can be any one of astaxanthin, carotenoids, coenzyme Q10 (“CoQ10”), flavonoids, glutathione Goji (wolfberry), hesperidin, lactowolfberry, lignan, lutein, lycopene, polyphenols, selenium, vitamin A, vitamin C, vitamin E, zeaxanthin, or any combinations thereof.

The nutritional product is preferably in an administrable form, for example an orally administrable form. The administrable form can be any one of a pharmaceutical formulation, a nutritional formulation, a dietary supplement, a functional food and a beverage product, or any combinations thereof.

The optional ingredients such as the mineral(s) includes boron, calcium, chromium, copper, iodine, iron, magnesium, manganese, molybdenum, nickel, phosphorus, potassium, selenium, silicon, tin, vanadium, zinc, or any combinations thereof.

The optional ingredients such as vitamin(s) includes vitamin A, Vitamin B1 (thiamine), Vitamin B2 (riboflavin), Vitamin B3 (niacin or niacinamide), Vitamin B5 (pantothenic acid), Vitamin B6 (pyridoxine, pyridoxal, or pyridoxamine, or pyridoxine hydrochloride), Vitamin B7 (biotin), Vitamin B9 (folic acid), and Vitamin B12 (various cobalamins; commonly cyanocobalamin in vitamin supplements), vitamin C, vitamin D, vitamin E, vitamin K, folic acid and biotin) essential in amounts for normal growth and activity of the body, or any combinations thereof.

In a further aspect, the nutritional product is used for preventing and/or alleviating, and/or compensating swallowing dysfunction in a patient in need of such treatment. As used herein, the terms prevent, prevention, alleviate, and compensate, and compensation include prophylactic or preventive treatment (that prevent and/or slow the development of a targeted pathologic condition or disorder) and therapeutic or disease-modifying/compensation treatment, including therapeutic measures that slow down, lessen symptoms of, and/or halt progression of a diagnosed pathologic condition or disorder; and treatment of patients at risk of contracting a disease or suspected to have contracted a disease, as well as patients who are ill or have been diagnosed as suffering from a disease or medical condition. The term does not necessarily imply that a subject is treated until total recovery. The terms prevent, prevention, alleviate, and compensate, and compensation also refer to the maintenance and/or promotion of health in an individual not suffering from a disease but who may be susceptible to the development of an unhealthy condition, such as nitrogen imbalance or muscle loss. The terms prevent, prevention, alleviate, and compensate, and compensation are also intended to include the potentiation or otherwise enhancement of one or more primary prophylactic or therapeutic measure. The terms prevent, prevention, alleviate, and compensate, and compensation are further intended to include the dietary management of a disease or condition or the dietary management for prophylaxis or prevention a disease or condition.

In a further aspect, the nutritional product is used for promoting swallowing safety and/or efficiency of nutritional products in a patient in need of same.

In a further aspect, the nutritional product is used for mitigating the risks of aspiration during swallowing of nutritional products in a patient in need of same.

Too much stress (shear during manufacture) can destroy the long-molecular chains of the beta-glucan and thereby destroy cohesiveness of the nutritional product. The methods described herein preferably use low-shear equipment for mixing all the ingredients and treating the nutritional product as described herein.

Typically a sufficient quantity of the thickener is admixed with a diluent in a suitable mixing vessel. A preferred mixing vessel can comprise a container having a size accommodating the amounts of the thickener and diluent desired to be suitably mixed. The vessel can be a commercially sized tank which may optionally include a cover, a particular shape, baffles, and/or a heat jacket. Other suitable useful mixing vessels include a drinking cup, bowls, household containers which can be opened or closed, a kitchen top mixer system, as well as any suitably sized container which can accommodate the amounts of the diluent and thickener to be suitably admixed.

As necessary or desired, minor components such as acids, bases, acidulates, chelating agents, flavors, colors, vitamins, minerals, sweeteners, insoluble foods and/or preservatives may be incorporated into the thickener and diluent admixture at any appropriate point during the preparation. Such minor components are preferably present in minor amounts and concentrations, i.e. a non-substantial amount as relates to thickening.

In an exemplary embodiment, depending on the specific admixing equipment used and the appropriate handling of the materials, the time for admixing the nutritional product is from about 2 minutes to about 180 minutes and preferably from about 5 minutes to about 60 minutes, although greater and lesser times may be employed if desired or necessary.

The packaging of the nutritional product is not critical as long as it delivers a thickness effective for a person afflicted with dysphagia. Illustratively, packaging may be totes, bins, foil pouches, buckets, bags, syringes or the like. If desired, use of a thickener can facilitate in-line mixing and preparation of thickened beverages in a beverage dispenser or container. Such a system can include a metering device and an in-line mixing system to dispense thickened beverages. Preferably the system is designed to dispense thickened or non-thickened beverages at the turn of a switch.

In an aspect, the thickener is effective for liquid foods. For example, an effective amount of the thickener can admixed with a liquid food which illustratively is selected from at least one of milk, human breast milk, cow's milk, soda, coffee, tea, juice (lemon, citrus, orange, apple), alcohol (beer, wine, or mixed drinks with less than about 20% alcohol), nutritional supplements, mixtures thereof and the like or a soup, broth, or food puree and the like. As used herein, the term “juice” includes puree, fruit juices including orange juice, vegetable juice and apple juice strained and unstrained, concentrated and fresh.

Non-limiting examples of suitable vessels to effectively admix the thickener and the liquid food include drinking cups, coffee cups, bowls, household containers which can be open top or closed top, a kitchen blender, a kitchen top mixer system, as well as any suitably sized container which can accommodate the materials to be admixed. Non-limiting examples of suitable instruments to carry out the admixing include forks, spoons, knives, hand mixers, kitchen blenders, kitchen top mixers, whisks, and any other appropriate agitation devices. Particularly suitable mixing containers have a lid or cover that can be attached to the container to allow the liquid food and the thickener to be shaken together with containment.

In an exemplary process, the amount of thickener employed in the admixture is that amount which provides a thickened liquid food which is capable of being consumed by effectively swallowing by a person afflicted with dysphagia.

Another advantage is that the nutritional products disclosed herein are safer to eat and to leave in the presence of persons with impaired mental judgment. Consumption of the nutritional products does not present a choking hazard. Dry powders put in the mouth and/or attempted to be swallowed before dissolving could present a danger to a patient with impaired mental judgment. In many facilities, open containers of powder are left on tables or in rooms or individual sized packets are served on trays. If a caregiver is somehow distracted, an impulsive eater, such as an individual afflicted with Huntington's chorea, could quickly try to consume the dry powder, at serious risk. The nutritional products disclosed herein are reconstituted and/or completely hydrated and thus face no such problems.

The thickener disclosed herein can be delivered to the end user fully, completely, and totally hydrated, and may minimize or avoid settling or separation when shipped. Preferably, the density will not change over time, and the product is stable. Consequently, in such embodiments, the same volume of thickener would thicken a liquid food to the same level of thickness whether the thickener is from the top or the bottom of a container. Liquid foods thickened by a thickener preferably do not continue to thicken after preparation. The thickener can be already hydrated in the nutritional product, and thus any concern over the fluid environment and its impact on hydration time is minimized or eliminated.

A radiological technique known commonly as the modified barium swallow or videofluoroscopic Swallow Study (VFSS) can be used to diagnose and to make therapeutic recommendations on thickened diets to those patients afflicted with dysphagia. Currently, hospitals or nursing homes or mobile diagnostic units prepare the test solutions in their own manner. There is little standardization on the thickness of these solutions. There are no means in place to ensure that the mealtime preparations served to diagnosed patients actually are the same thickness as the test preparations.

The thickener compositions disclosed herein can provide the opportunity to link the thicknesses prepared during the modified barium swallow to what is prepared in food service and/or bedside and/or at home. The thickener compositions disclosed herein can reduce the variability of final thickness in different liquid foods and thus reduce the variability of mixing technique. The elimination of clumping and mixing time factors can reduce the variability between what happens during a modified barium swallow and in food service and/or bedside and/or at home for actual consumption.

Another common diagnostic technique of dysphagia is the fiberoptic endoscopic evaluation of swallow (FEES). In this technique, an endoscope is inserted through the patient's nasal passage into the throat to directly observe the patient's swallow function. In an aspect, the thickener disclosed herein can be used to thicken test preparations used in this evaluation technique.

In some embodiments of the methods disclosed herein, the method comprises identifying a level of severity of the swallowing disorder in the patient; and selecting, based on the level of severity of the swallowing disorder in the patient, the amount of the thickener for diluting, wherein the amount of the thickener is selected from a plurality of predetermined amounts that each corresponds to a different level of swallowing disorder severity. As a non-limiting example, the thickener can be provided in a container attached to a metering pump; one pump of the metering pump can dispense a predetermined amount of the thickener that is suitable for an individual with mild dysphagia, two pumps of the metering pump can dispense a predetermined amount of the thickener that is suitable for an individual with moderate dysphagia, and three pumps of the metering pump can dispense a predetermined amount of the thickener that is suitable for an individual with severe dysphagia.

In another aspect, the present disclosure provides a system for production of a homogenous single phase beverage for administration to an individual having dysphagia, the system comprising: a first container containing a thickener comprising a beta-glucan; a second container containing a stabilizer comprising comprises at least one of Na₂HPO₄, sodium azide, potassium sorbate, sodium benzoate, sodium citrate, or protease; a metering device connected to the container and configured to dispense a first amount of the thickener that is approximately equal to a first predetermined amount and a second amount of the stabilizer that is approximately equal to a second predetermined amount. The system can further comprise a static in-line mixer configured to mix the thickener into the nutritional product and/or a nozzle configured to dispense the homogenous single phase beverage.

### EXAMPLES

The following non-limiting examples are experimental examples supporting one or more embodiments provided by the present disclosure.

### Example 1: Change of Viscosity and Relaxation Time with Time

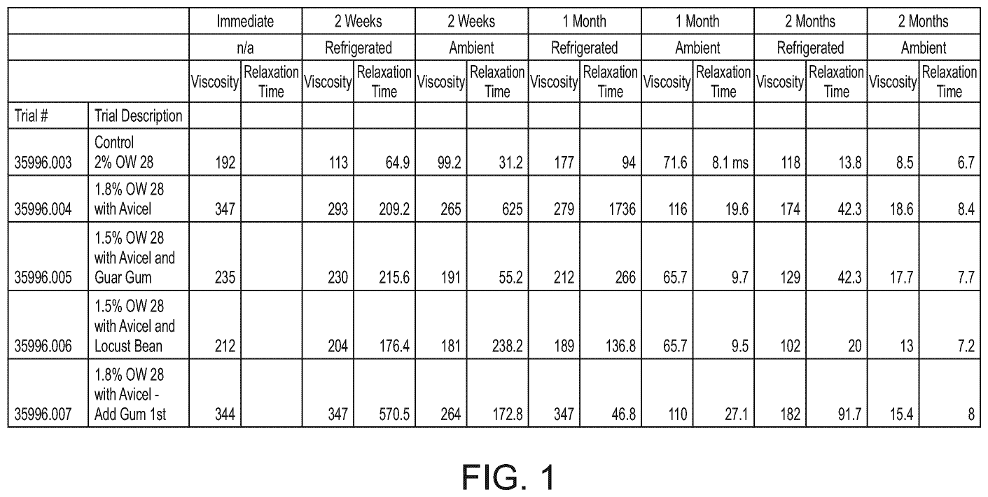

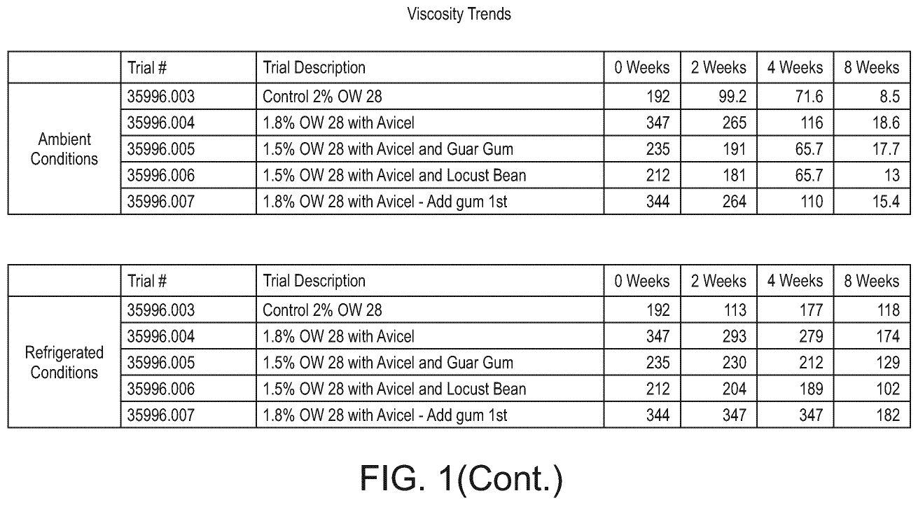

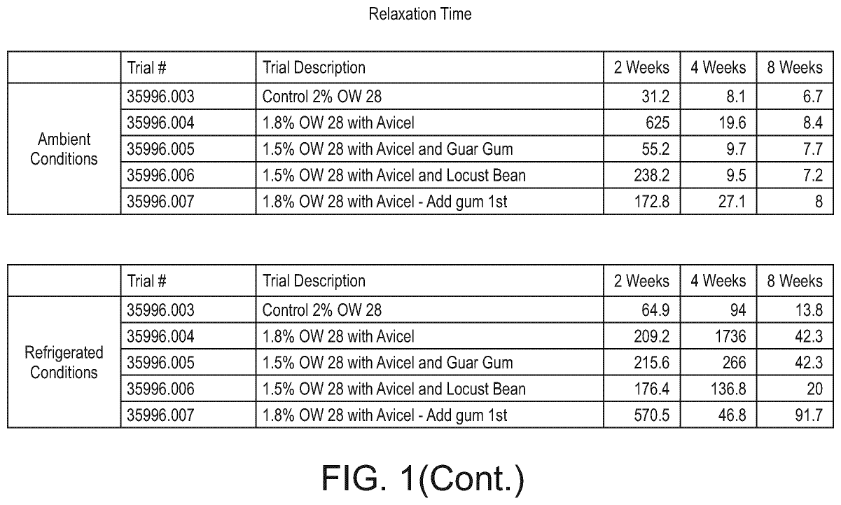

FIG. 1 shows the viscosities and relaxation times at different times and different temperatures (refrigerated and ambient) of samples:
Trial No. 35996.003: Control 2% OatWell 28 (OW 28)
Trial No. 35996.004: 1.8% OW 28 with Avicel
Trial No. 35996.005: 1.5% OW 28 with Avicel and Guar Gum
Trial No. 35996.006: 1.5% OW 28 with Avicel and Locust Bean
Trial No. 35996.007: 1.8% OW 28 with Avicel—Add gum first

The results show that the viscosity decreases with time. By one month in the ambient condition, extension of most samples is poor. By two months in the refrigerated condition, cohesion is mostly gone. Cohesion and viscosity maintain a little longer in the refrigerated condition, but are still degrading.

### Example 2: Impact of pH on Cohesion and Viscosity of OatWell 28 Solutions

Recipes of samples for several pH targets are as follows:

| | | Sodium Citrate | | |
|---|---|---|---|---|
| pH Target | RO Water | (0.1M) | Citric Acid | OatWell 28 |
| 3 | 500 mL | 4.85% = 24.25 g | 16.041% = 80.21 g | 10 g |
| 4 | 500 mL | 11.975% = 59.88 g | 11.385% = 56.93 g | 10 g |
| 5 | 500 mL | 19.1% = 95.5 g | 6.73% = 33.65 g | 10 g |
| Neutral (no Acid- | 500 mL | 0% | 0% | 10 g |
| 6.5-7 pH) | | | | |

### Mixing Procedure:

Add 500 mL of RO water;
Add sodium citrate and citric acid to water to the thermomixer and agitate;
Heat up water to 60° C. on the thermomixer;
Add 10 g of OatWell 28 once temperature is at 60° C.;
Make sure all the ingredient is in the water, for example, by scraping the agitators and
sides while placing the thermomixer on pause;
Mix for 30 minutes;
Centrifuge;
Pour the thermomix extract into a beaker;
Make sure to stir with spoon before loading centrifuge tubs;
Centrifuge for 20 minutes (5000 rcf for 20 minutes at 6G); and
Decant the centrifuge tubes.
Sensory;

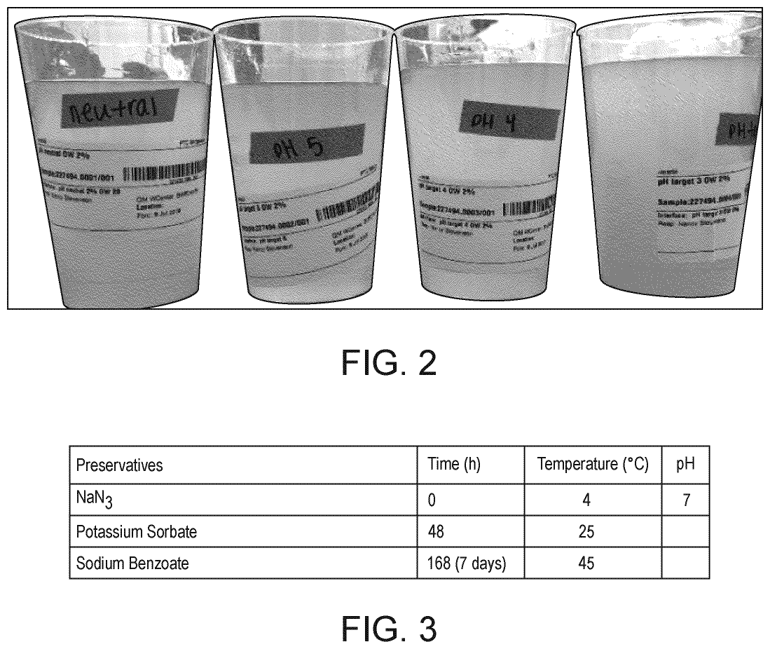

FIG. 2 is a picture of all the samples. As shown in the picture, the color difference was not severe, but there is a slight color change as the sample is more acidic. The sample with a pH of 3 has a slightly more yellow/orange hue. The other three samples have negligible differences. It shows that when the pH is below 4, there is a higher risk of color change.

Additionally, the sample at a pH of 3 had a fruity/acidic/chemical type smell in addition to the oat smell. This was detected at the pH of 5 and 4 as well when the samples were hot, but once cooled, the only detectable note was the oat/pasta smell.

### Analysis of the Samples:

Centrifuged samples were brought to room temperature (stored for a couple hours) before measuring on CaBER. CaBER relaxation time was calculated using the CaBER equipment. Viscosity was measured using an Anton Paar and parallel plates. Viscosity was measured at 50-1 seconds shear rate. The pH was measured using a pH meter.

| | | CaBER | |
|---|---|---|---|
| | | Relaxation Time | Viscosity at 50⁻¹ s |
| pH Target | pH Actual | (ms) | shear rate |
| 3 | 2.78 | 90.3 | 217 |
| 4 | 3.73 | 97.9 | 84.5 |
| 5 | 4.62 | 47.9 | 26.1 |
| Neutral (no Acid- | 6.60 | 110.7 | 159 |
| 6.5-7 pH) | | | |

### Example 3: pH test with the use of hydrochloric acid with no buffer

### Mixing Procedure:

Add 500 mL of RO water;
Add hydrochloric acid to pH target and agitate;
Heat up water to 60° C. on the thermomixer;
Add 10 g of OatWell 28 once the temperature is 60° C.;
Make sure all of the ingredient is in the water, for example, by scraping the agitators
and sides while placing the thermomixer on pause;
Mix for 30 minutes;
Check pH at the end of mixing.
Centrifuge:
Pour the thermomixer extract into a beaker;
Make sure to stir with spoon before loading centrifuge tubs;
Centrifuge for 20 minutes (5000 rcf for 20 minutes at 6G).
Analysis of the samples:

Centrifuged samples were brought to room temperature (stored for a couple hours) before measuring on CaBER. CaBER relaxation time was calculated using the CaBER equipment. Viscosity was measured using an Anton Paar and parallel plates. Viscosity was measured at 50-1 seconds shear rate. The pH was measured using a pH meter.

| | | CaBER | Viscosity at 50₋₁ |
|---|---|---|---|
| | | Relaxation Time | s shear rate at |
| pH Target | pH Actual | (ms) | 25 C. (mPa) |
| 3 | 6.58 | 108 | 149 |
| 4 | 6.32 | 118 | 136 |
| 5 | 6.44 | 118 | 142 |
| Neutral (no Acid- | 6.5 | 119 | 135 |
| 6.5-7 pH) | | | |

The results indicate that neutral conditions are preferable for thin, cohesive properties.

### Example 4: Role of Microorganisms in the Degradation of the Cohesive Property—(Impact on MW)

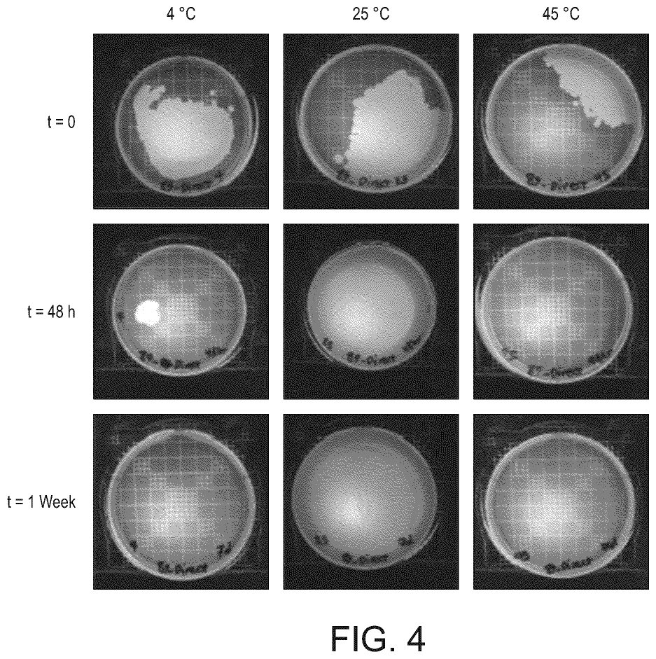

To determine the cause of the degradation, the inventors investigated the role of microorganisms according to the table in FIG. 3. FIGS. 4-8 show the microbiological cultures at different hours and different temperatures.

FIG. 3 shows the microbiological cultures in the control experiment. In the control samples, after 1 week in 45° C., there was no microbiological activity. It is possible that the high temperature killed the microorganisms.

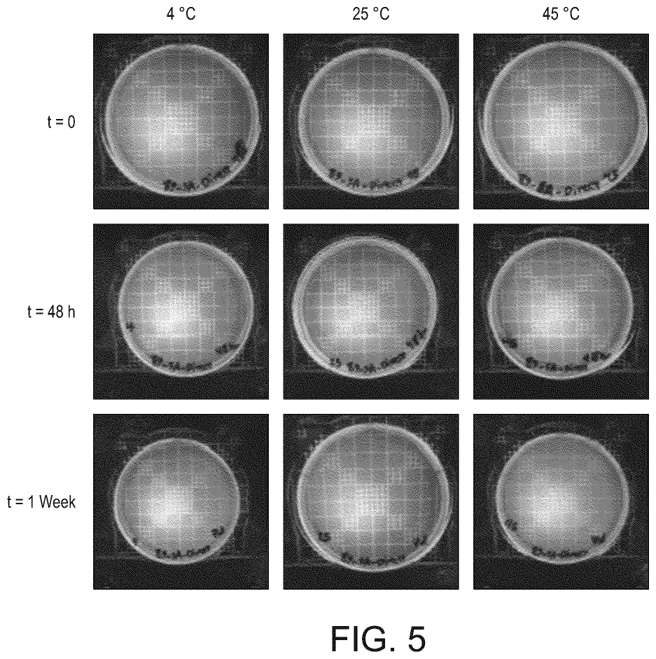

FIG. 5 shows the microbiological cultures in the presence of sodium azide (NaN₃). Sodium azide kills all the microorganisms at time 0. There is no microbiological activity in the cultures even after 1 week.

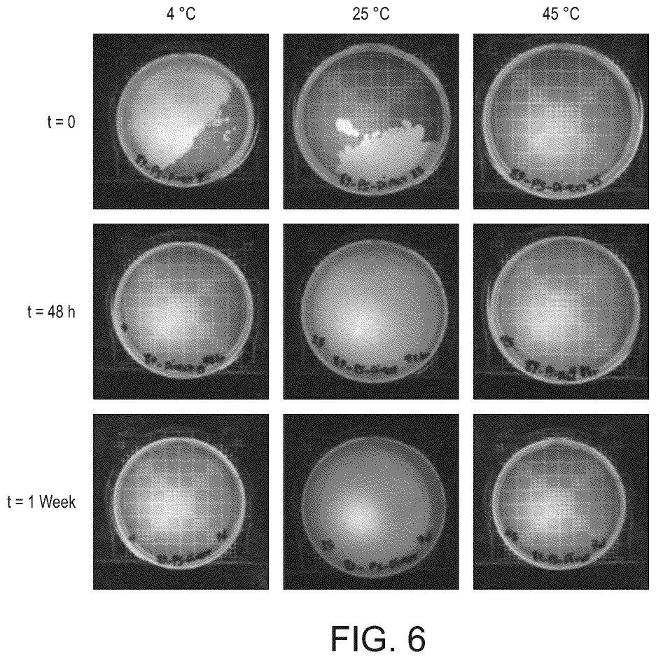

FIG. 6 shows the microbiological cultures in the presence of potassium sorbate. Potassium sorbate kills all the microorganisms in 45° C. at t=0, but in 25° C., it can not prevent the growth of the microorganisms.

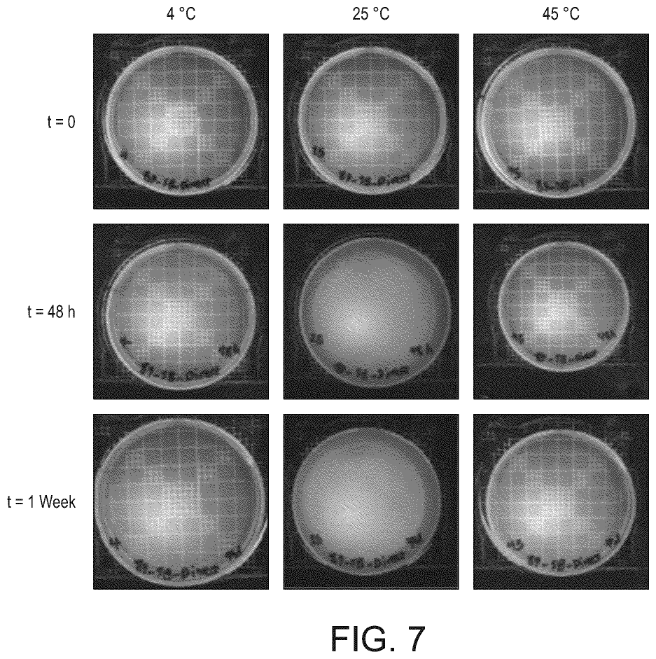

FIG. 7 shows the microbiological cultures in the presence of sodium benzoate. These cultures show that sodium benzoate prevents the microorganisms activity in both 4° C. and 45° C., but at 25° C., the growth of the microorganisms is not prevented.

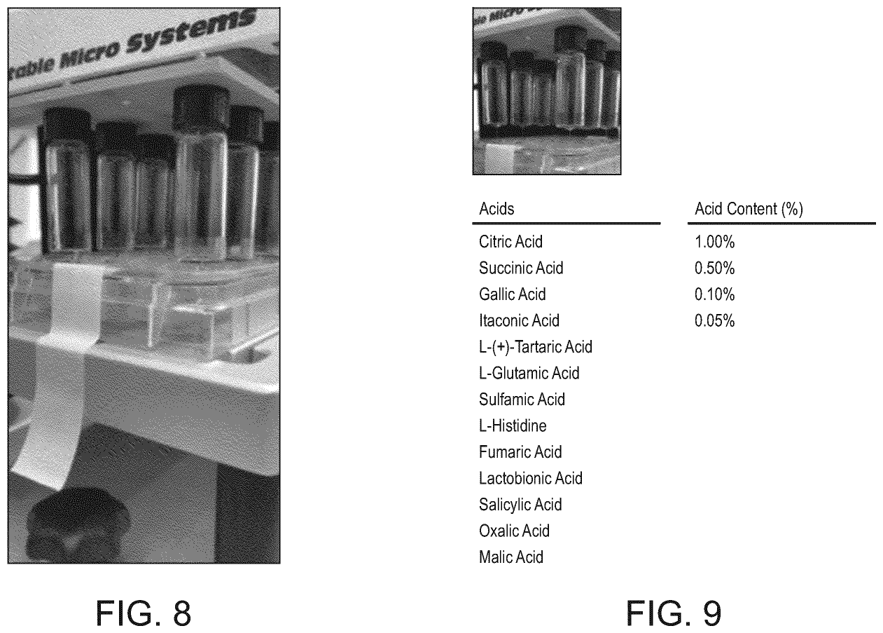

FIG. 8 shows the stringiness of oat extracts containing sodium azide and potassium sorbate after 2 weeks:
Sample 1: NaN₃ at 4° C.
Sample 2: NaN₃ at 25° C.
Sample 3: NaN₃ at 45° C.
Sample 4: Potassium Sorbate at 4° C.
Sample 5: Potassium Sorbate at 25° C.
Sample 6: Potassium Sorbate at 45° C.

The stringiness of the oat extracts containing sodium azide and potassium sorbate after 2 weeks were investigated. Samples containing sodium azide kept the cohesiveness. The sample with potassium sorbate at 25° C. did not show any stringiness. The results show that the microorganisms activity is one of the most effective reasons of the degradation of the cohesive behavior.

To determine the role of acids on the cohesive behavior, the solutions of different acids with different concentrations were prepared, as shown in FIG. 9. Citric Acid, Succinic Acid, Gallic Acid, Itaconic Acid, L-(+)-Tartaric Acid, L-Glutamic Acid, Sulfamic Acid, L-Histidine, Fumaric Acid, Lactobionic Acid, Salicylic Acid, Oxalic Acid, and Malic Acid, each in concentrations of 1.00%, 0.50%, 0.10%, and 0.05% were used. Using the texture analyzer, the cohesive behavior of the samples were investigated. Citric acid and tartaric acid did not decrease the stringiness.

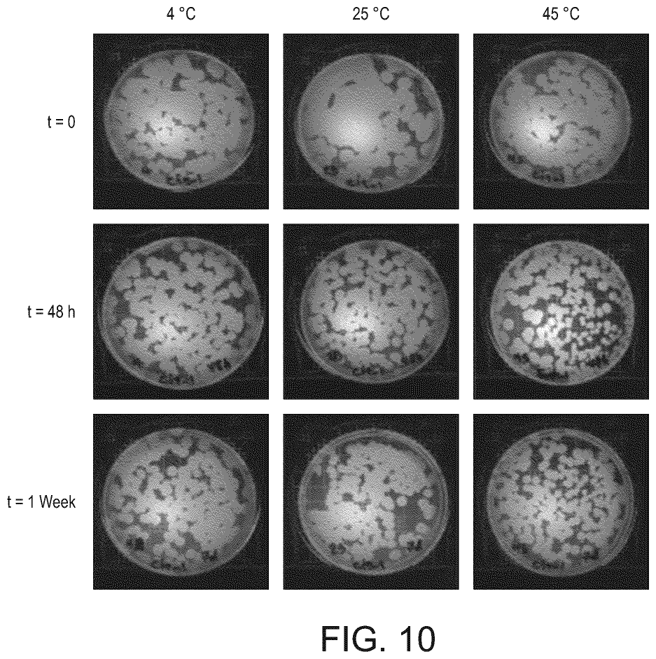

FIG. 10 shows the microbiological cultures in the presence of citric acid (pH 3.5).

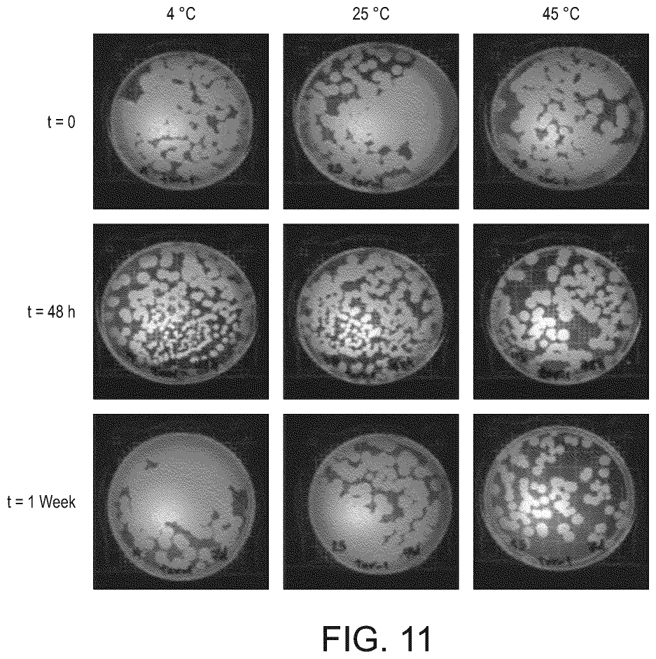

FIG. 11 shows the microbiological cultures in the presence of tartaric acid (pH 2.6). It seems that high temperature and tartaric acid can decrease the microorganisms activity.

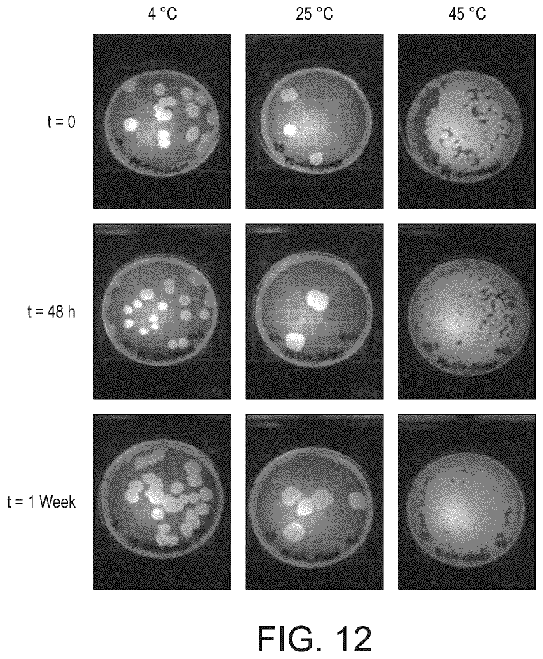

FIG. 12 shows the microbiological cultures in the presence of potassium sorbate and citric acid. It seems that potassium sorbate and citric acid can not prevent the microorganisms activity.

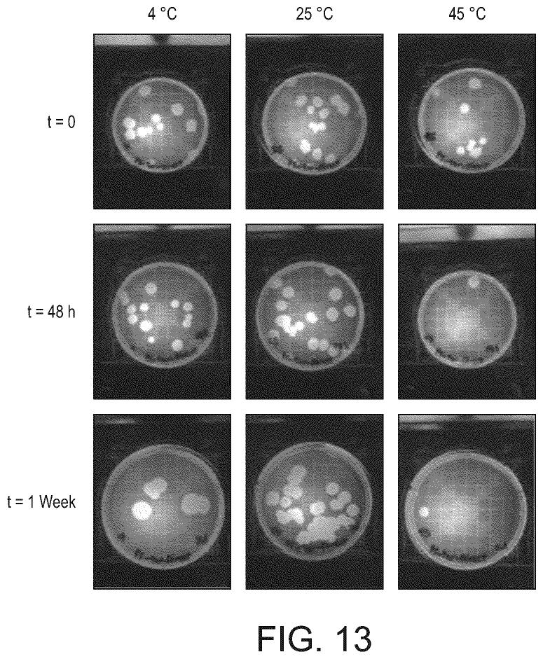

FIG. 13 shows the microbiological cultures in the presence of potassium sorbate and tartaric acid. It seems that potassium sorbate and tartaric acid can decrease the microorganisms activity.

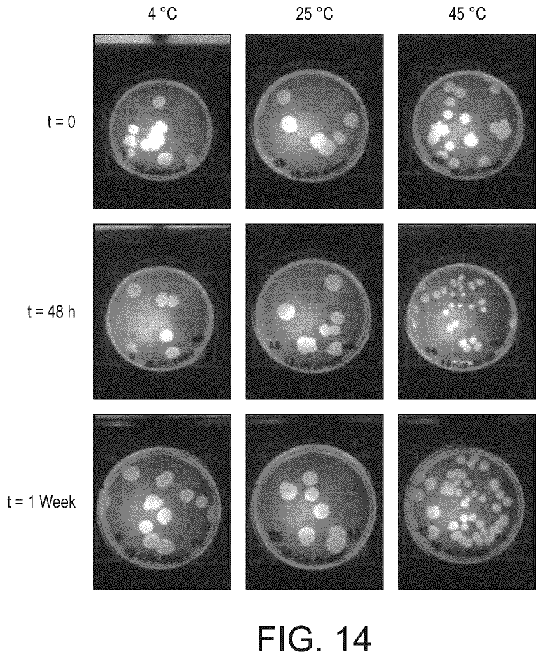

FIG. 14 shows the microbiological cultures in the presence of sodium benzoate and citric acid. It seems that this combination can control the microorganisms activity.

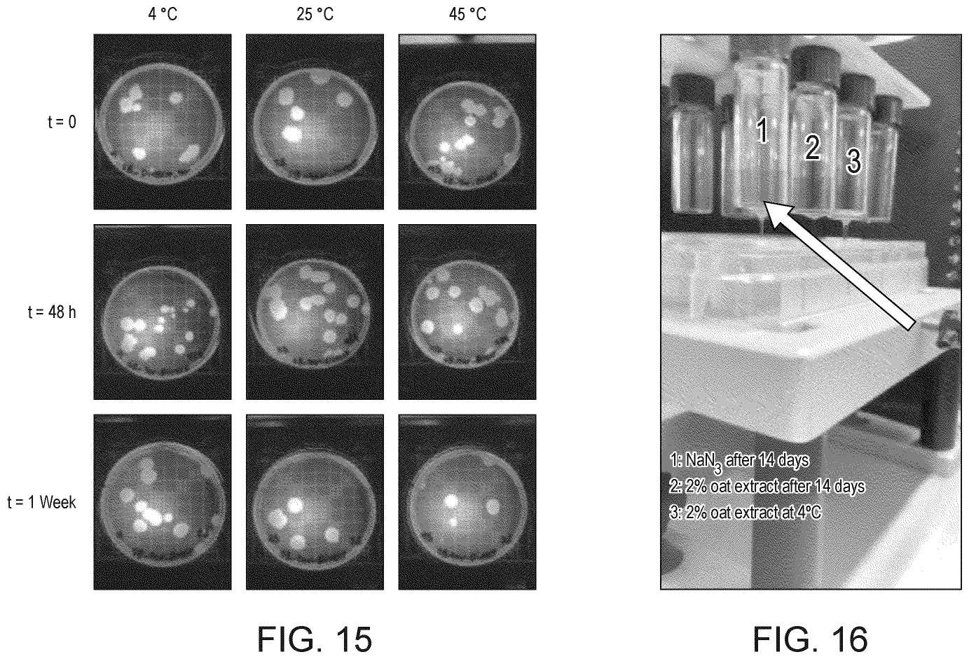

FIG. 15 shows the microbiological cultures in the presence of sodium benzoate and tartaric acid. It seems that this combination can control the microorganisms activity.

FIG. 16 shows stringiness of the samples:
1: NaN₃ after 14 days
2: 2% oat extract after 14 days at room temperature
3: 2% oat extract at 4° C.

The stringiness of the oat extracts containing sodium azide was compared with 2% oat extract which was kept at room temperature and also 2% oat extract which was kept at 4° C.: Sodium azide keeps the cohesiveness, and it is the same as the 2% oat extract which was kept at 4° C. 2% oat extract which was kept at room temperature did not have any cohesiveness.

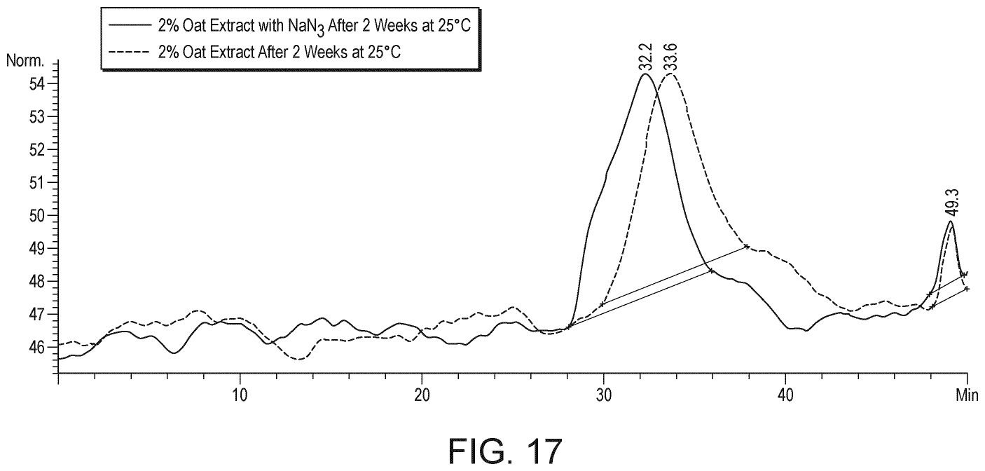

FIG. 17 shows the retention times using size exclusion chromatography for (a) 2% oat extract with NaN₃ after 2 weeks at 25° C. (the blue line) and (b) 2% oat extract after 2 weeks at 25° C. (the red line).

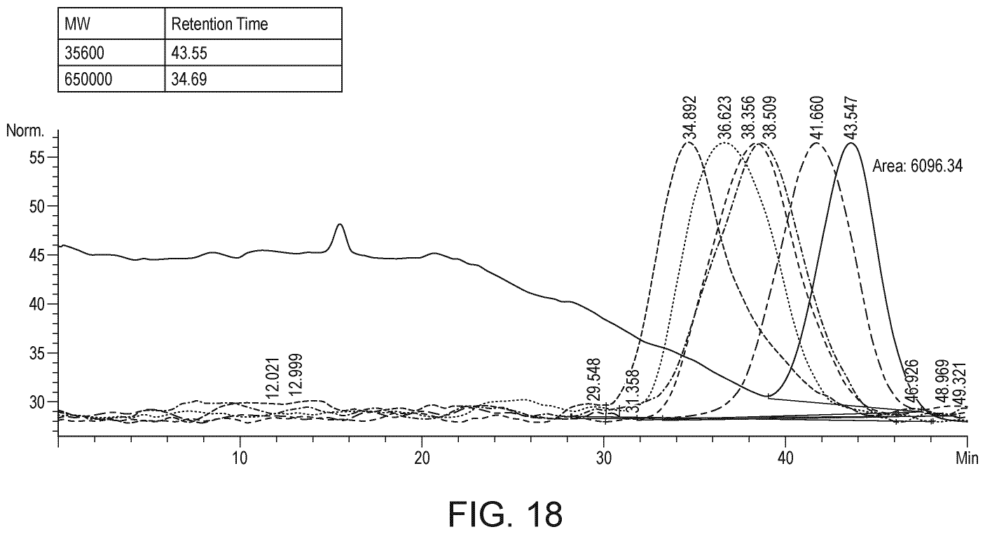

FIG. 18 shows the retention times of the standard β-glucan samples.

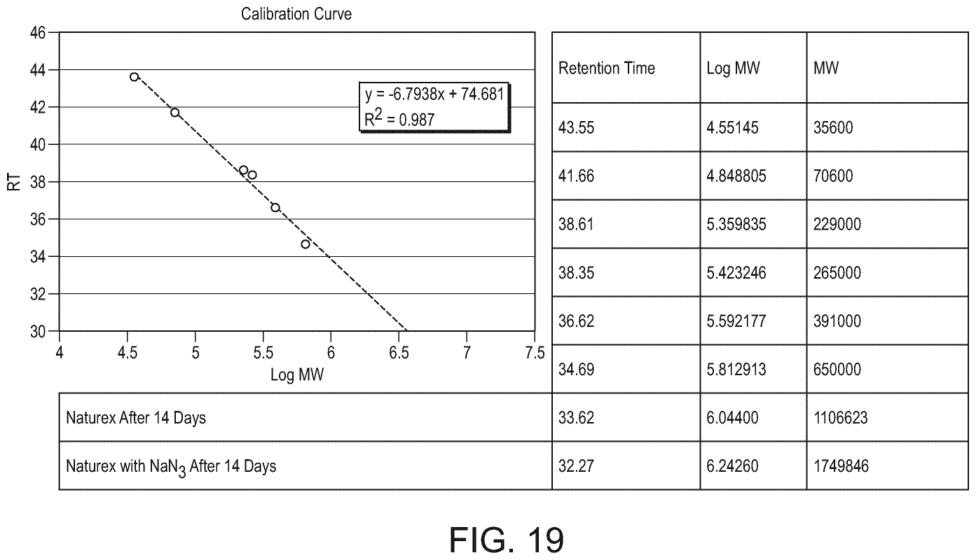

FIG. 19 shows the molecular weight of the samples.

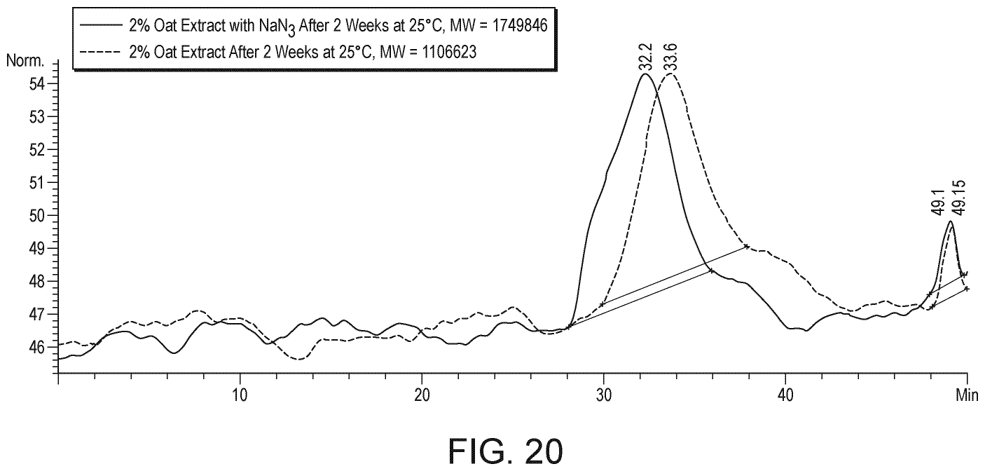

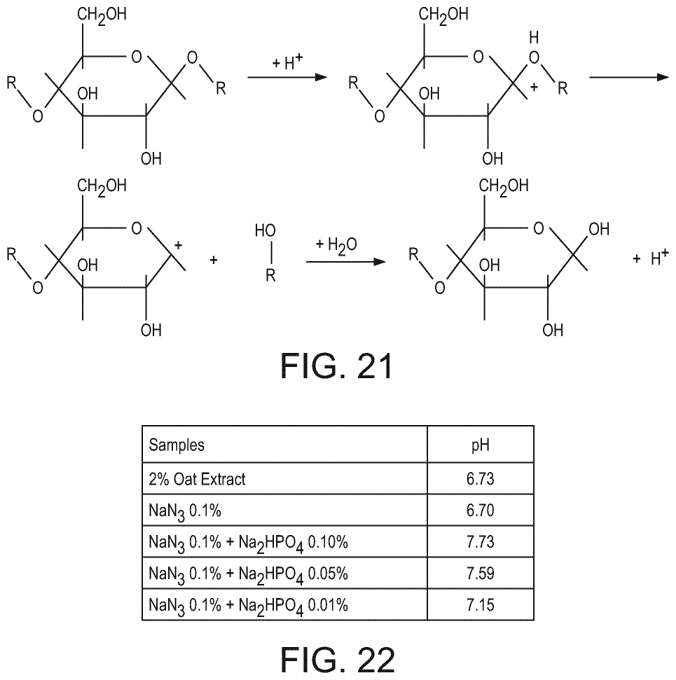

FIG. 20 shows the retention times using size exclusion chromatography of (a) 2% oat extract with NaN₃ after 2 weeks at 25° C., MW=1749846 (the blue line) and (b) 2% oat extract after 2 weeks at 25° C., MW=1106623 (the red line). NaN₃ prevents any bacterial activity, and as shown in the figure, its molecular weight is much higher than the oat extract without any preservative. Also, it has been shown that the NaN₃ solution keeps its stringiness even after 2 weeks at room temperature.

### Example 5: Acidic Hydrolysis of the β-Glucan

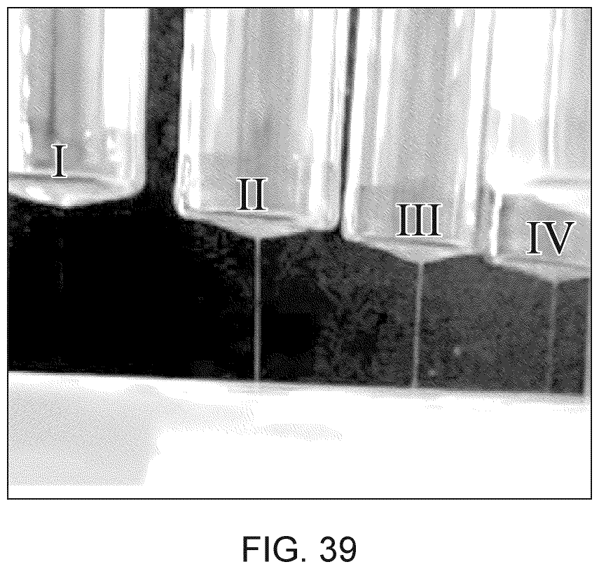

To prevent the acidic hydrolysis of the β-glucan, Na₂HPO₄ was used as an additive. FIG. 39 shows the reaction between β-glucan and H+ from the Na₂HPO₄ additive.

FIG. 22 shows the list of samples used and their pH values. With adding the Na₂HPO₄, the pH can be increased to mild basic.

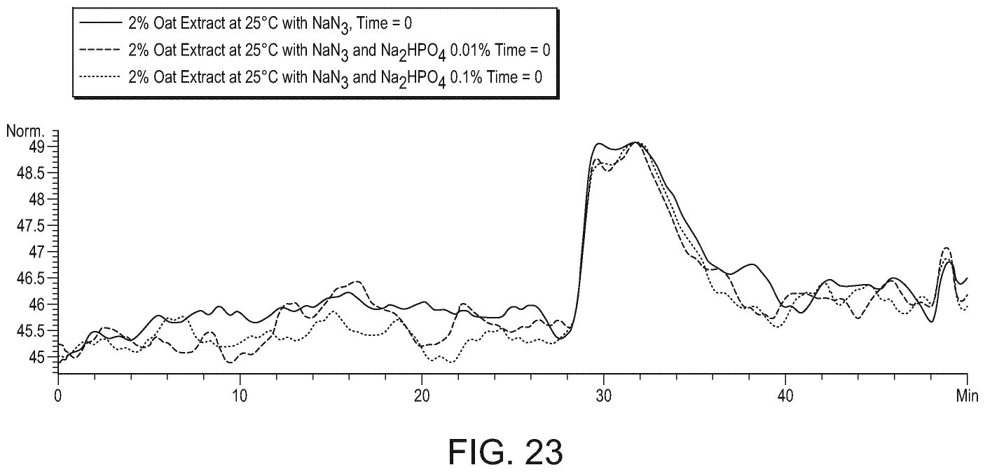

FIG. 23 shows the retention times using size exclusion chromatography of (a) 2% oat extract at 25° C. with NaN₃, time=0 (the blue line), (b) 2% oat extract at 25° C. with NaN₃ and Na₂HPO₄ 0.01% time=0 (the red line), and (c) 2% oat extract at 25° C. with NaN₃ and Na₂HPO₄ 0.1% time=0 (the green line).

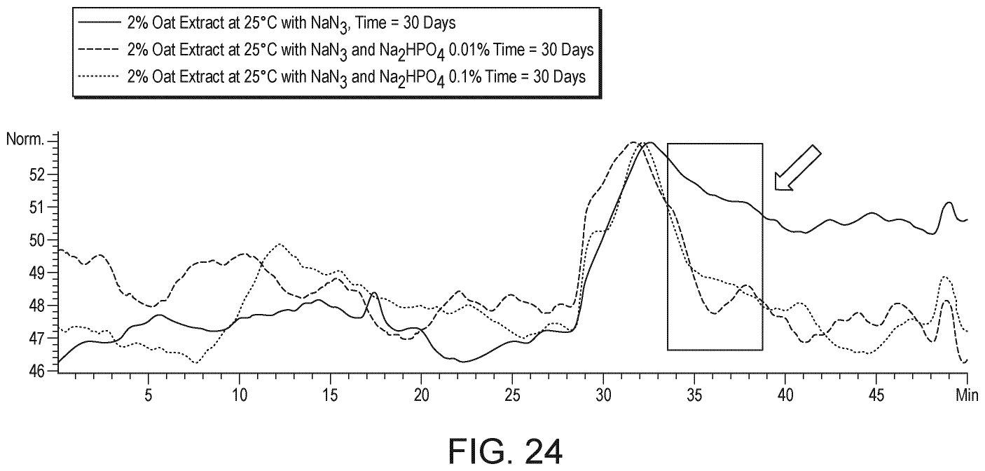

FIG. 24 shows the retention times using size exclusion chromatography of (a) 2% oat extract at 25° C. with NaN₃, time=30 days, (b) 2% oat extract at 25° C. with NaN₃ and Na₂HPO₄ 0.01% time=30 days, and (c) 2% oat extract at 25° C. with NaN₃ and Na₂HPO₄ 0.1% time=30 days. The shaded portion shows that the presence of Na₂HPO₄ can prevent the β-glucan degradation.

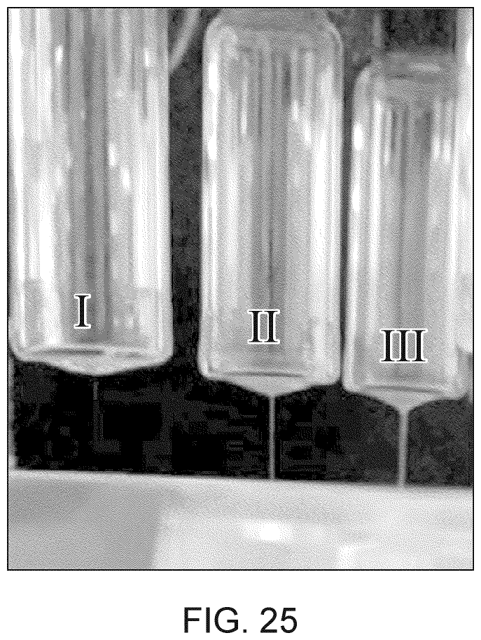

FIG. 25 shows the cohesiveness of the samples containing Na₂HPO₄:
I. 2% oat extract at 25° C. with NaN₃, time=35 days
II. 2% oat extract at 25° C. with NaN₃ and Na₂HPO₄ 0.01% time=35 days
III. 2% oat extract at 25° C. with NaN₃ and Na₂HPO₄ 0.1% time=35 days

After 35 days, samples II and III have higher cohesiveness compare to the sample I which just has NaN₃.

### Example 6: The Effect of Thiosulfate

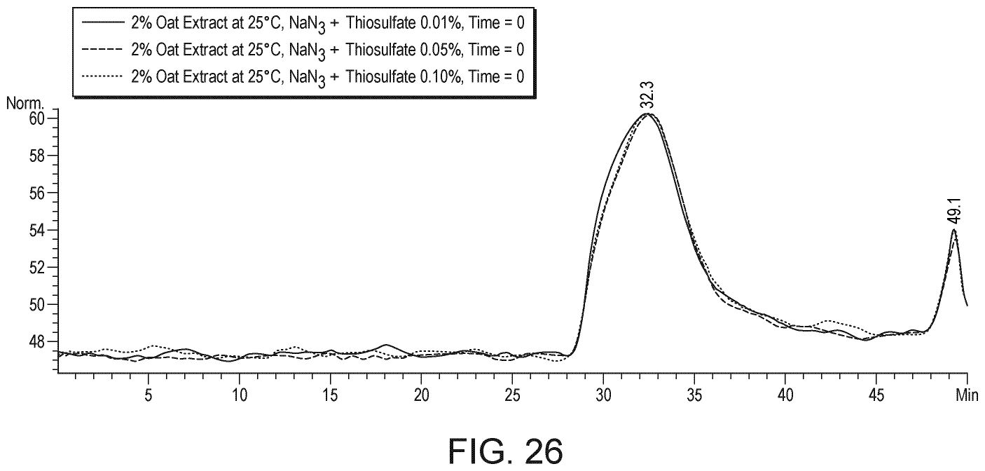

FIG. 26 shows the retention times using size exclusion chromatography of (a) 2% oat extract at 25° C., NaN₃+Thiosulfate 0.01%, time=0 (the blue line), (b) 2% oat extract at 25° C., NaN₃+Thiosulfate 0.05%, time=0 (the red line), and (c) 2% oat extract at 25° C., NaN₃+Thiosulfate 0.10%, time=0 (the green line).

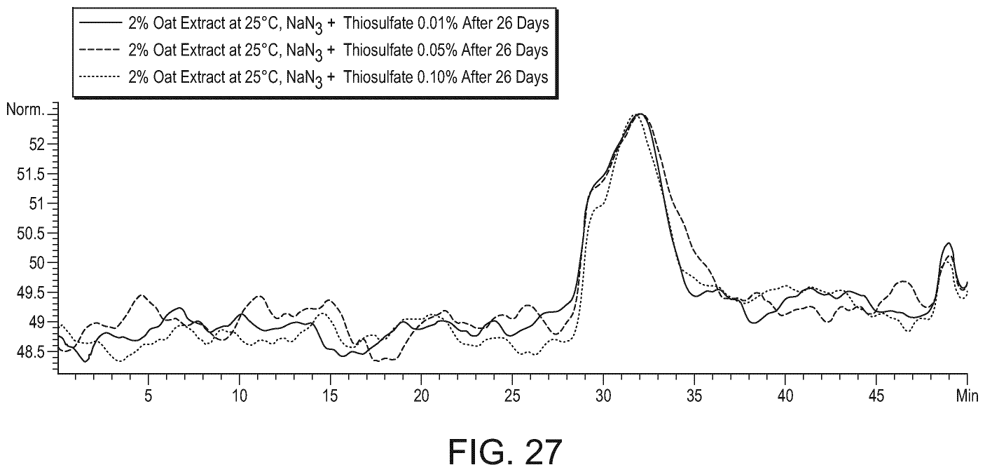

FIG. 27 shows the retention times using size exclusion chromatography of (a) 2% oat extract at 25° C., NaN₃+Thiosulfate 0.01% after 26 days (the blue line), (b) 2% oat extract at 25° C., NaN₃+Thiosulfate 0.05% after 26 days (the red line), and (c) 2% oat extract at 25° C., NaN₃+Thiosulfate 0.10% after 26 days (the green line). It seems that the samples containing lower concentrations of thiosulfate are more stable. Using texture analyzer also showed the same result.

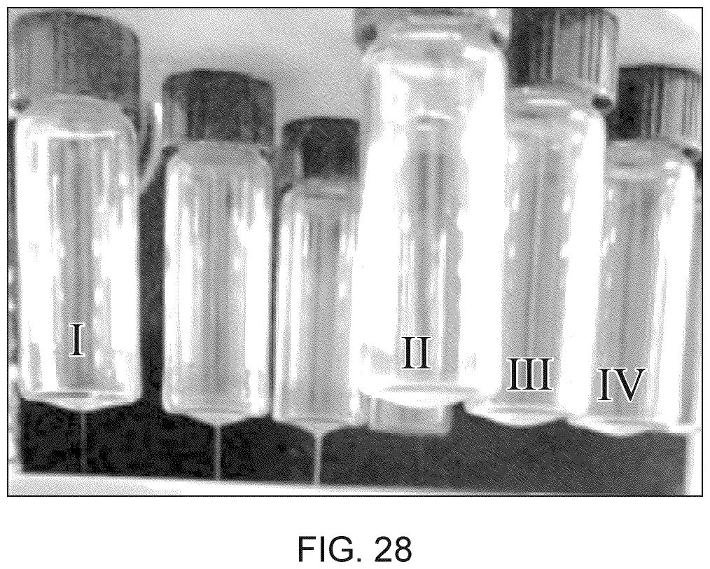

FIG. 28 shows cohesiveness of the solutions containing the thiosulfate:
I. 2% oat extract at 25° C., NaN₃ after 30 days
II. 2% oat extract at 25° C., NaN₃+Thiosulfate 0.01% after 26 days
III. 2% oat extract at 25° C., NaN₃+Thiosulfate 0.05% after 26 days
IV. 2% oat extract at 25° C., NaN₃+Thiosulfate 0.10% after 26 days

Sample I still has a better cohesiveness even after 30 days, so the use of thiosulfate did not improve the stability of the glucan.

### Example 7: The Effect of N₂ and O₂ on MW of β-Glucan

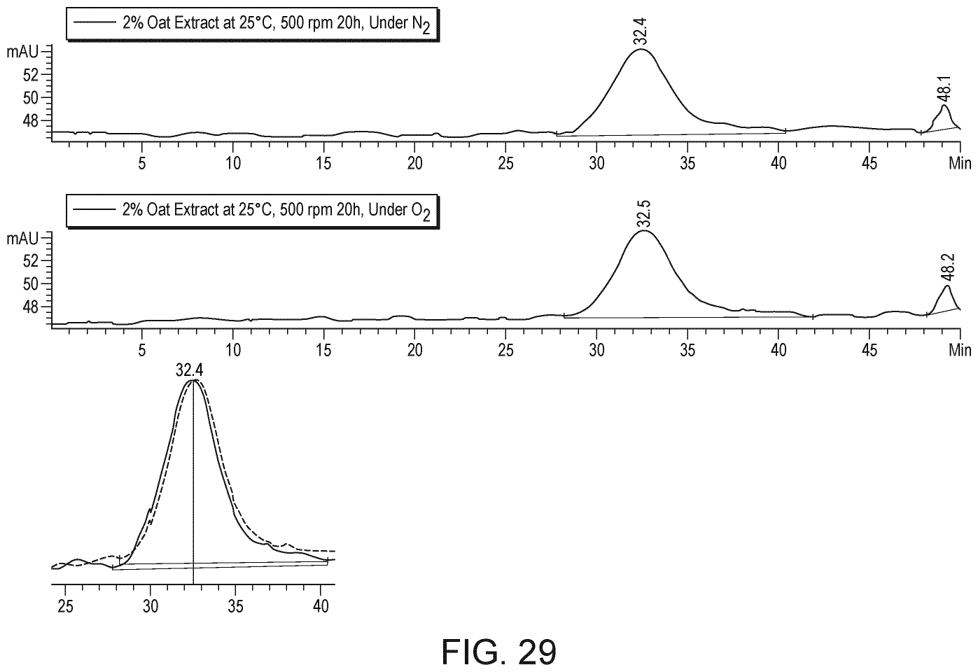

FIG. 29 shows the retention times using size exclusion chromatography of (a) 2% oat extract at 25° C., 500 rpm 20 h, Under N₂ (the top panel) and (b) 2% oat extract at 25° C., 500 rpm 20 h, Under O₂ (the bottom panel).

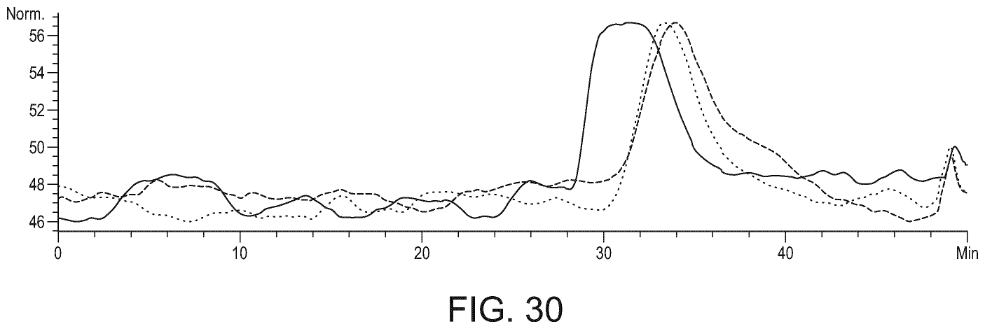

FIG. 30 shows the retention times using size exclusion chromatography of (a) 2% oat extract at 25° C., no rpm, 48 h (the blue line), (b) 2% oat extract at 25° C., 500 rpm 48 h, Under N₂ (the red line), and (c) 2% oat extract at 25° C., 500 rpm 48 h, Under O₂ (the green line). The results show that β-glucan under O₂ atmosphere is more stable than the β-glucan under N₂ atmosphere.

### Example 8: The Effect of N₂ and O₂ on MW of β-Glucan in the Presence of NaN₃

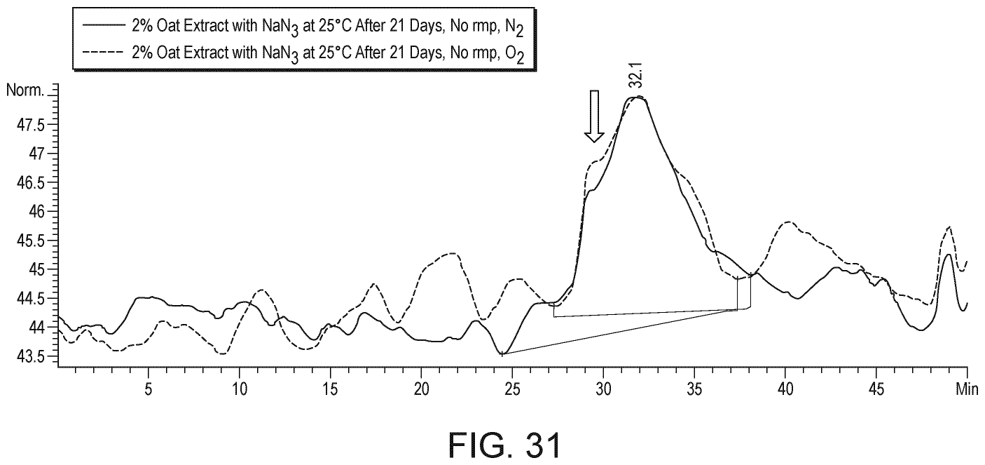

FIG. 31 shows the retention times using size exclusion chromatography of (a) 2% oat extract with NaN₃ at 25° C. after 21 days, no rpm, N₂ (the blue line) and (b) 2% oat extract with NaN₃ at 25° C. after 21 days, no rpm, O₂ (the red line). In the presence of O₂, the portion of the glucan with higher MW is more than the other.

### Example 9: The Effects of Using Both NaN₃ and Protease on MW

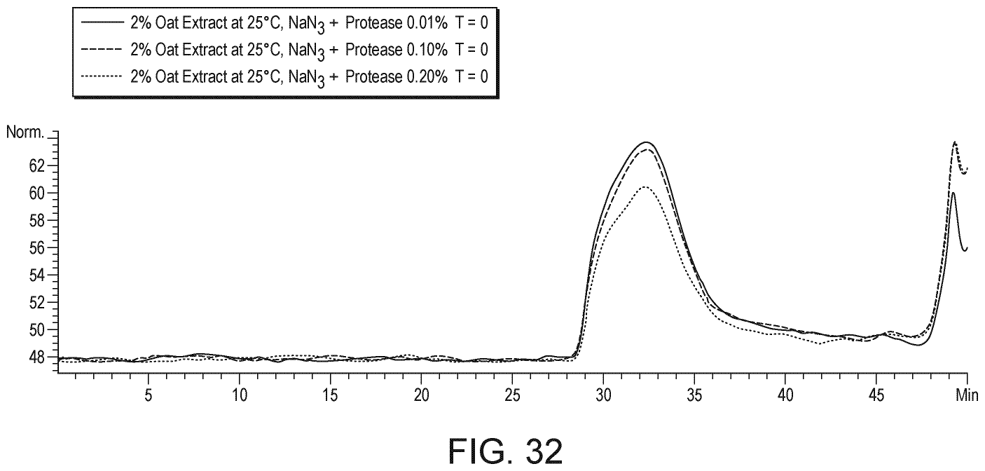

FIG. 32 shows the retention times using size exclusion chromatography of (a) 2% oat extract at 25° C., NaN₃+Protease 0.01% t=0 (the blue line), (b) 2% oat extract at 25° C., NaN₃+Protease 0.10% t=0 (the red line), and (c) 2% oat extract at 25° C., NaN₃+Protease 0.20% t=0 (the green line).

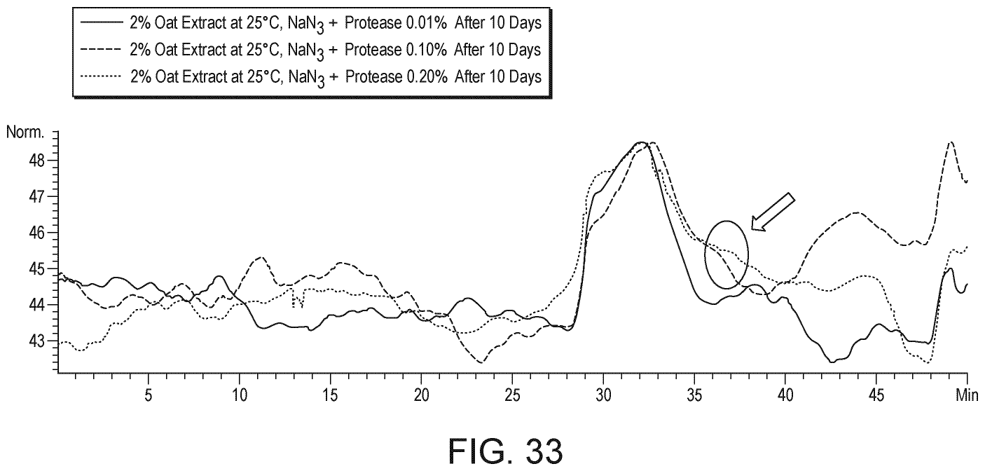

FIG. 33 shows the retention times using size exclusion chromatography of (a) 2% oat extract at 25° C., NaN₃+Protease 0.01% after 10 days (the blue line), (b) 2% oat extract at 25° C., NaN₃+Protease 0.10% after 10 days (the red line), and (c) 2% oat extract at 25° C., NaN₃+Protease 0.20% after 10 days. It is shown that increased concentrations of protease resulted in more degradation.

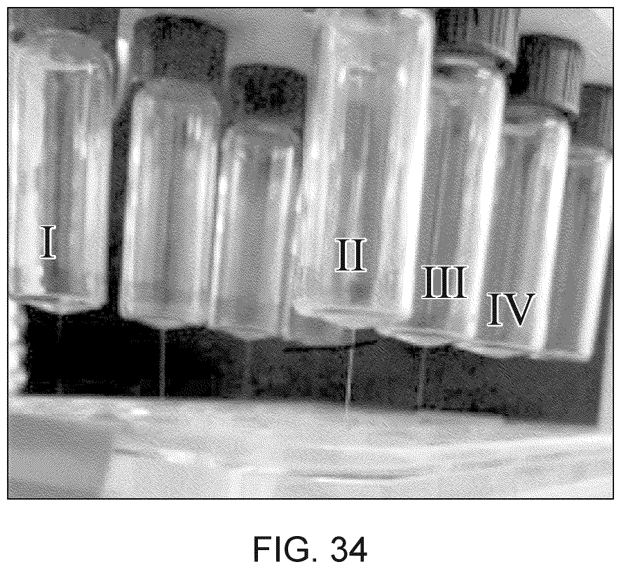

FIG. 34 shows the cohesiveness of the solutions containing protease:
I. 2% oat extract at 25° C., NaN₃ after 10 days
II. 2% oat extract at 25° C., NaN₃+Protease 0.01% after 10 days
III. 2% oat extract at 25° C., NaN₃+Protease 0.10% after 10 days
IV. 2% oat extract at 25° C., NaN₃+Protease 0.20% after 10 days

Compare to the solution which just has NaN₃, other solutions have higher cohesiveness. The samples with lower concentrations of protease have higher cohesiveness. The use of protease can improve the desired stability of β-glucan by the denaturation of the enzymes.

### Example 10: Glucanase Enzyme Activity

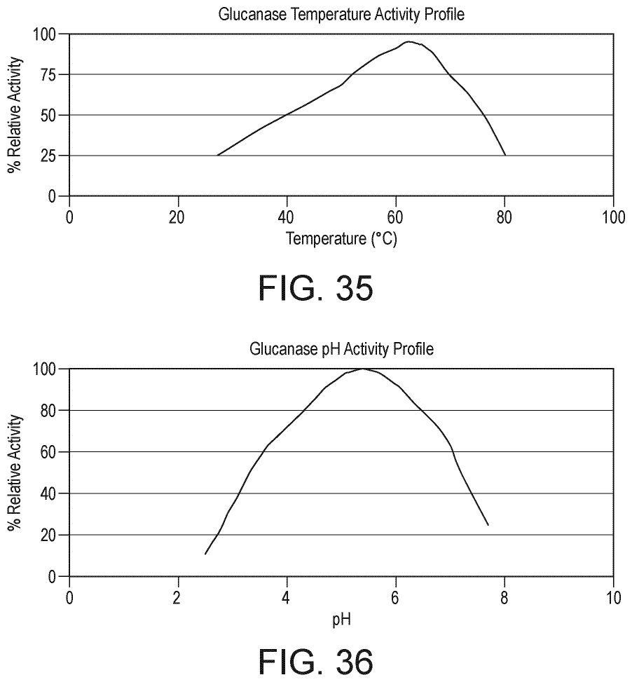

FIG. 35 shows the Glucanase temperature activity profile. FIG. 36 shows the Glucanase pH activity profile.

The enzymatic activity of Glucanase is effective in the temperature range from 40° C., to 75° C., with the optimum performance at 60° C. The pH range for the activity of Glucanase is approximately from 3.5-6.5, with an optimum performance at pH 5.5. Also, the use of Na₂HPO₄ could increase the pH and prevent the enzymatic activity.

### Example 11: The Role of Temperature on Deactivation of the Enzymes

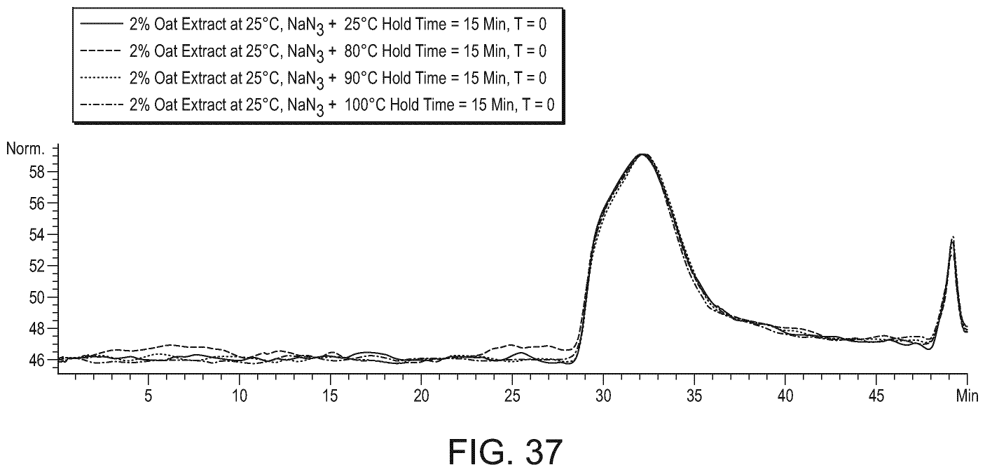

FIG. 37 shows the retention times using size exclusion chromatography of (a) 2% oat extract at 25° C., NaN₃+25° C. hold time=15 min, t=0 (the blue line), (b) 2% oat extract at 25° C., NaN₃+80° C. hold time=15 min, t=0 (the red line), (c) 2% oat extract at 25° C., NaN₃+90° C. hold time=15 min, t=0 (the green line), and (d) 2% oat extract at 25° C., NaN₃+100° C. hold time=15 min, t=0 (the pink line).

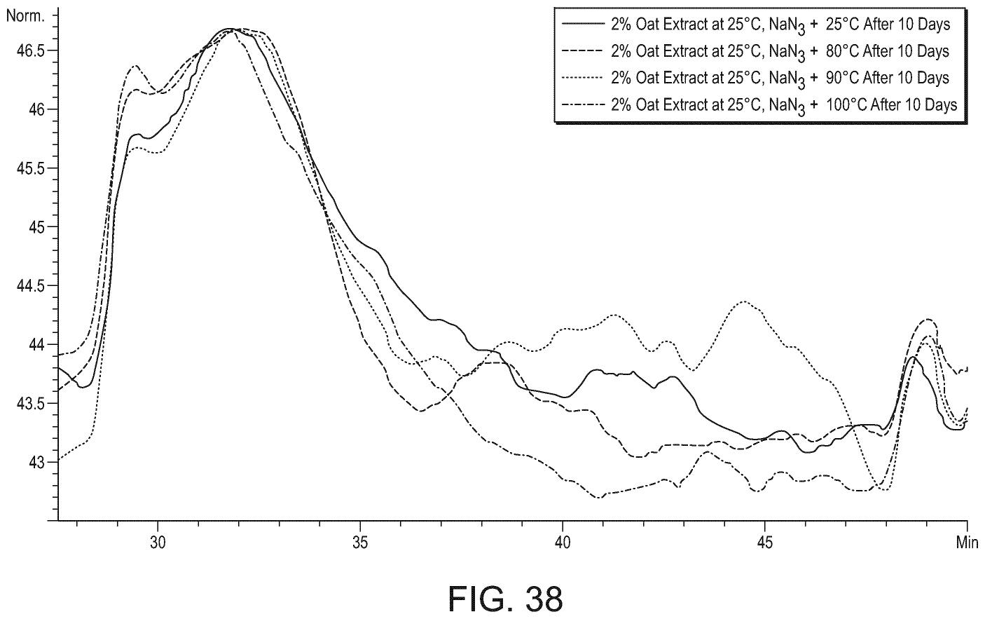

FIG. 38 shows the retention times using size exclusion chromatography of (a) 2% oat extract at 25° C., NaN₃+25° C. after 10 days (the blue line), (b) 2% oat extract at 25° C., NaN₃+80° C. after 10 days (the red line), (c) 2% oat extract at 25° C., NaN₃+90° C. after 10 days (the green line), and (d) 2% oat extract at 25° C., NaN₃+100° C. after 10 days (the pink line). The patterns of degradations compare to the time=0 are different. It means that temperature has an effect on enzymatic activity.

FIG. 39 shows the cohesiveness of the solutions:
I. 2% oat extract at 25° C., NaN₃+25° C. after 15 days
II. 2% oat extract at 25° C., NaN₃+80° C. after 15 days
III. 2% oat extract at 25° C., NaN₃+90° C. after 15 days
IV. 2% oat extract at 25° C., NaN₃+100° C. after 15 days

In general, the results show that heating could improve the stability of the β-glucan because after 15 days all the heated samples show a better cohesiveness.

### Example 12: The Role of Temperature on Deactivation of the Enzymes: Microwave Heating with NaN₃

The unwanted β-glucan-depolymerizing enzymes can be denatured at high temperature. However, the heat-based denaturation is not an instantaneous process, and the enzymatic reactions are easily accelerated at elevated temperatures. Thus, the denaturation temperature should be reached as rapidly as possible.

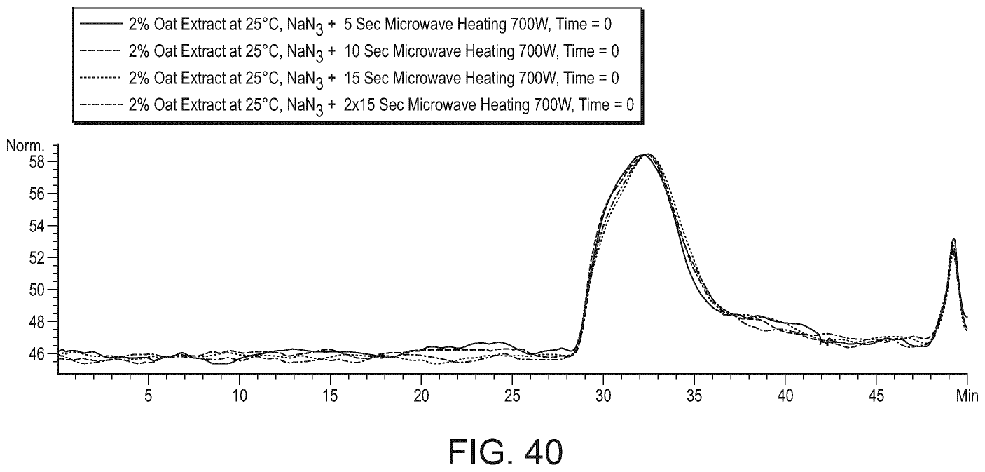

FIG. 40 shows the retention times using size exclusion chromatography of (a) 2% oat extract at 25° C., NaN₃+5 sec microwave heating 700 W, time=0 (the blue line), (b) 2% oat extract at 25° C., NaN₃+10 sec microwave heating 700 W, time=0 (the red line), (c) 2% oat extract at 25° C., NaN₃+15 sec microwave heating 700 W, time=0 (the green line), and (d) 2% oat extract at 25° C., NaN₃+2×15 sec microwave heating 700 W, time=0 (the pink line).

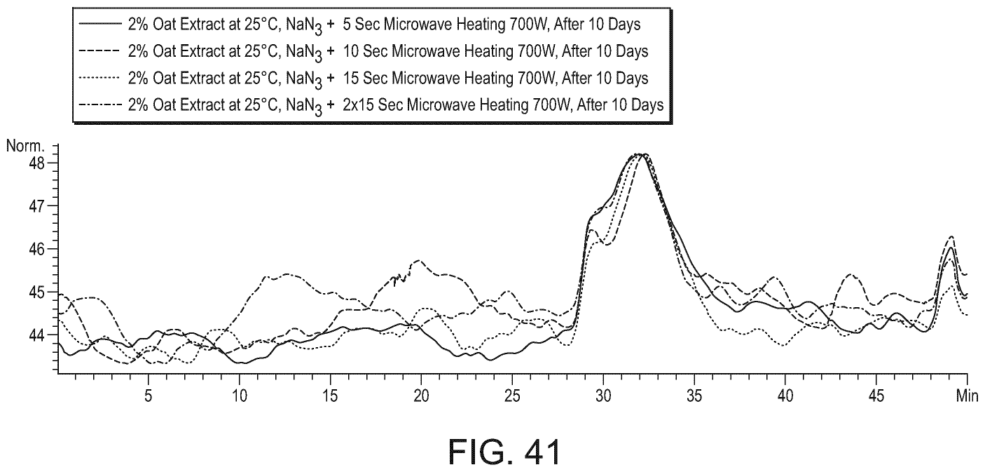

FIG. 41 shows the retention times using size exclusion chromatography of (a) 2% oat extract at 25° C., NaN₃+5 sec microwave heating 700 W, after 10 days (the blue line), (b) 2% oat extract at 25° C., NaN₃+10 sec microwave heating 700 W, after 10 days (the red line), (c) 2% oat extract at 25° C., NaN₃+15 sec microwave heating 700 W, after 10 days (the green line), and (d) 2% oat extract at 25° C., NaN₃+2×15 sec microwave heating 700 W, after 10 days (the pink line). The patterns of degradations are different. It means that temperature has an effect on enzymatic activity.

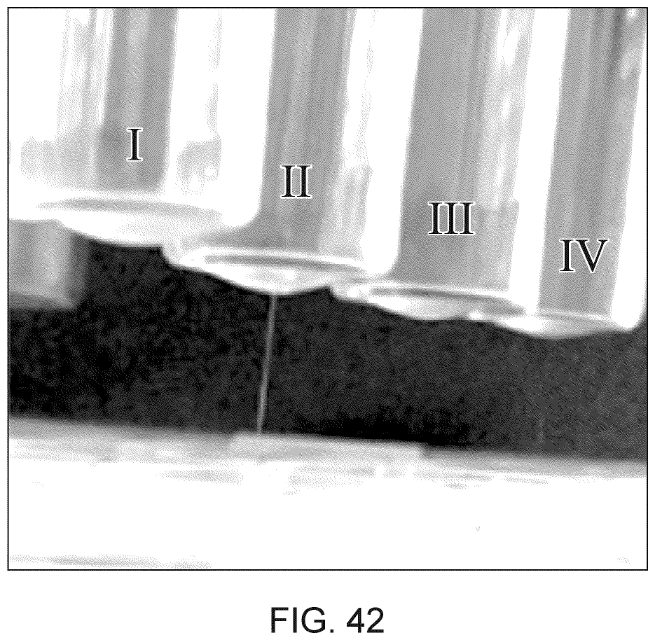

FIG. 42 shows the cohesiveness of the solutions:
I. 2% oat extract at 25° C., NaN₃+5 sec microwave heating after 15 days
II. 2% oat extract at 25° C., NaN₃+10 sec microwave heating after 15 days
III. 2% oat extract at 25° C., NaN₃+15 sec microwave heating after 15 days
IV. 2% oat extract at 25° C., NaN₃+2×15 sec microwave heating after 15 days

The results show that 10 second microwave heating had the best result.

### Example 13: The Role of Temperature on Deactivation of the Enzymes: Microwave Heating without NaN₃

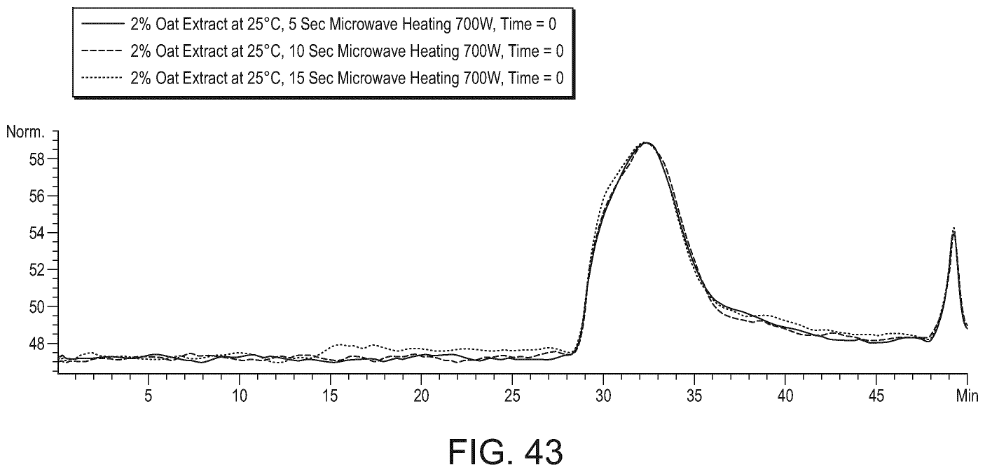

FIG. 43 shows the retention times using size exclusion chromatography of (a) 2% oat extract at 25° C., 5 sec microwave heating 700 W, time=0 (the blue line), (b) 2% oat extract at 25° C., 10 sec microwave heating 700 W, time=0 (the red line), and (c) 2% oat extract at 25° C., 15 sec microwave heating 700 W, time=0 (the green line).

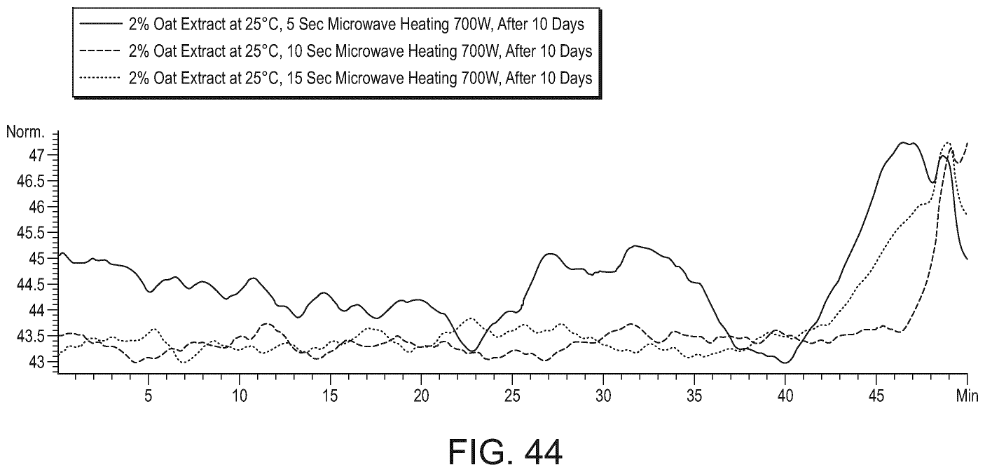

FIG. 44 shows the retention times using size exclusion chromatography of (a) 2% oat extract at 25° C., 5 sec microwave heating 700 W, after 10 days (the blue line), (b) 2% oat extract at 25° C., 10 sec microwave heating 700 W, after 10 days (the red line), and (c) 2% oat extract at 25° C., 15 sec microwave heating 700 W, after 10 days (the green line). After 10 days, the samples did not show any cohesiveness.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of enhancing physical stability of a nutritional product consumed in liquid form, the nutritional product containing a beta-glucan, the method comprising at least one of preventing degradation of the beta-glucan in the nutritional product;
reducing degradation of the beta-glucan in the nutritional product;
maintaining viscosity and/or relaxation time of the nutritional product; or
reducing a rate of decreasing of the viscosity and/or the relaxation time of the nutritional product.

2. (canceled)

3. The method of claim 1 comprising a treatment selected from the group consisting of:
adding to the nutritional product a stabilizer selected from the group consisting of Na₂HPO₄, sodium azide, potassium sorbate, sodium benzoate, sodium citrate, citric acid, hydrochloric acid, tartaric acid, protease, and combinations thereof;
heating the nutritional product to a temperature between about 30° C. and about 100° C.;
adjusting a pH of the nutritional product to from about 3 to about 7; and
combinations thereof.

4-26. (canceled)

27. A method of making a nutritional product, the method comprising:
preparing the nutritional product by diluting a thickener comprising a beta-glucan in a diluent; and
subjecting the nutritional product to a treatment selected from the group consisting of:
adding to the nutritional product a stabilizer selected from the group consisting of Na₂HPO₄, sodium azide, potassium sorbate, sodium benzoate, sodium citrate, citric acid, hydrochloric acid, tartaric acid, protease, and combinations thereof;
heating the nutritional product to a temperature between about 30° C. and about 100° C.;
adjusting a pH of the nutritional product to from about 3 to about 7; and
combinations thereof.

28. The method of claim 27, wherein the stabilizer comprises at least one of Na₂HPO₄ or sodium azide.

29. The method of claim 27, wherein the stabilizer comprises at least one of sodium azide or protease.

30-34. (canceled)

35. The method of claim 27 comprising at least one of adding NaN₃ or microwave heating the nutritional product.

36. The method of claim 27 comprising microwave heating the nutritional product for about 10 seconds.

37. The method of claim 27 comprising adjusting a pH of the nutritional product to from about 6 to about 7.

38. A nutritional product comprising a beta-glucan and a stabilizer selected from the group consisting of Na₂HPO₄, sodium azide, potassium sorbate, sodium benzoate, sodium citrate, citric acid, hydrochloric acid, tartaric acid, protease, and combinations thereof.

39. The nutritional product of claim 38, wherein the stabilizer comprises at least one of Na₂HPO₄ or sodium azide.

40-45. (canceled)

46. The nutritional product of claim 38, wherein the nutritional product has a pH from about 6 to about 7.

47. The nutritional product of claim 38 further comprising a component selected from the group consisting of a protein, a fat, a fiber, a carbohydrate, a prebiotic, a probiotic, an amino acid, a fatty acid, a phytonutrient, an antioxidant, and combinations thereof.

48. The nutritional product of claim 38, wherein the nutritional product is in an administrable form selected from the group consisting of a pharmaceutical formulation, a nutritional formulation, a dietary supplement, a functional food and beverage product, and a ready-to-drink (RTD) beverage.

49-57. (canceled)
